(19) United States
(12) Patent Application Publication
(10) Pub. No.: US 2005/0105116 A1
(43) Pub. Date: May 19, 2005

(54) Document processing apparatus and document processing method

(75) Inventor: Kazufumi Kobashi, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/986,007

(22) Filed: Nov. 12, 2004

(30) Foreign Application Priority Data
Nov. 13, 2003 (JP) 2003-383903

(51) Int. Cl. G06F 15/00; G06F 17/21

(52) U.S. Cl. 358/1.12; 358/1.18

(57) ABSTRACT

Document processing apparatus which reflects post-processing data, which is recognized by a scanner, on document setting of a generated electronic document. The document processing apparatus comprises: a registration unit which registers data indicative of post-processing setting, which has been performed on a sheet document in page unit, as document setting of the generated electronic document; and a generation unit which generates printing data by reflecting the registered document setting on the generated electronic document.

### FIELD OF THE INVENTION

The present invention relates to a document processing apparatus and a document processing method, and more particularly, to a document processing apparatus and a document processing method for inputting document data from a paper document, which is generated by a document processing program or an image editing program or the like, and reflecting post-processing data of the inputted document as document setting on an electronic document which is generated based on the inputted document data.

### BACKGROUND OF THE INVENTION

Depending on the type of data, e.g., texts, charts, images and so on, the structures defining the data and editing operation on the data are different. For this reason, various application programs are provided in accordance with the type of data. A user uses an appropriate application program for each type of data. For instance, to edit texts, a user uses a text processing program; to edit a chart, a user uses a spreadsheet program; and to edit an image, a user uses an image editing program.

In this manner, it is a general procedure to use an appropriate application program for each type of data. However, a document generated by a user is generally constructed with plural types of data including texts and charts, texts and images, and so on, rather than only one type of data having texts only, charts only, or images only. To generate a desired document including plural types of data, a user has to print data for each application program using the printing function of each application program, and has to combine the printouts in desired order.

Alternatively, a program so-called office suite, which forms an integrated application package of various application programs, provides a function for combining data generated by respective application programs and constructing a document. In a case where the integrated application package is used, a user can integrate the data, which is generated by respective application programs, into one desired document by using a particular application program included in the integrated application package.

However, for instance, in a case of paginating printouts of a desired document which is a combined document including data produced by various application programs, all the necessary data must be printed out and integrated into a document once, then page numbers must be determined. Then, the determined page number is written, by the respective application programs, on each page of the document generated by each application program (hereinafter referred to as a logical page or a document page). Even in a case where the application program has a pagination function, if there is a non-consecutive part, the user still has to designate the page number. Moreover, if the pages of the desired document are rearranged, page numbers have to be renumbered accordingly. Furthermore, in a case of not changing the content of the data but simply changing the format of the document, e.g., a case of rearranging a page layout to print the document in one page instead of plural pages (hereinafter referred to as a physical page or a printing page), or a case of changing a printing form from a single-sided printing to a double-sided printing, editing and printing has to be performed again by each application program.

As described above, because the application program controlling data differs for each type of data, an interface between application programs has to be provided by the user's man power. This requires a user tremendous effort and causes reduced productivity. Furthermore, because such document involves a lot of man power, there are higher risks of errors.

Meanwhile, in a case where a desired document is generated by the integrated application software, respective data can be arranged in accordance with the state of data without requiring printouts. Therefore, not as much effort is necessary as in the case of generating the desired document by combining printouts. However, the application programs that can be used for editing and generating various data are limited to the one included in the integrated application package, and a user-desired application program is not always included. Furthermore, since the desired document generated by the integrated application package is a single document file, controlling such as editing and outputting is performed in file unit. For this reason, there are many limitations due to functions of the application program, even in a case where a user tries to set a format on part of the document file. For instance, for each portion where layout is changed, format setting must be changed and printing must be performed again. Therefore, the disadvantages in terms of requiring much effort and low productivity are the same as the aforementioned method.

In view of the above-described background, a printing application program currently under consideration handles plural documents and image files as one integrated document by converting the documents and image files generated by respective application programs to an integrated format. In this printing application program, the integrated document is hierarchically managed by the following units: the entire document, chapter, and page. Setting for post-processing such as stapling can be performed for each chapter in accordance with user's operation (e.g., Japanese Patent Application Laid-Open No. 2003-091380).

Meanwhile, the most general method of making a copy of a paper document is to use a copying machine. A current digital copying machine has a read-image transmission function, which transmits image data of a document as a file, read by the scanner unit, to a host computer (external device) connected through a network (e.g., Japanese Patent Application Laid-Open No. 2002-132642).

By setting a document in the scanner unit of a copying machine, inputting the number of copies to be made, and pressing a copy button, the designated number of copies can be generated. However in this method, if the document is placed at an angle and read by the scanner, copies of this page are all printed at an angle. Furthermore, in a case of making copies by a copying machine, there is a problem of image quality deterioration due to noise and black dots added to the document. Moreover, there is another problem in that it is impossible to remove unnecessary page numbers, a header and footer added to the document, or to add page numbers, a header and footer. There is still another problem in that it is impossible to perform advanced editing on the document, e.g., adjusting the printing position of a particular page of the document. To solve these problems, two methods have conventionally been implemented.

One is a method executed by a single copying machine. A document read by a scanner unit of the copying machine is first stored in the copying machine. A user confirms the state of the stored document and performs print setting for improving the above-described problems. Then, copying of the stored document is executed in accordance with the print setting (e.g., Japanese Patent Application Laid-Open No. 7-283933). This method is used in a case of automatically performing skew correction and removal of noise/black dots. However, advanced editing, such as editing of a header/footer, adjustment of a printing position in page unit or the like, is not very often implemented because of the problem of processing capacity or operability of the copying machine. Even if it is implemented, it is implemented with poor operability.

Another method is to transfer document data read by a scanner of a copying machine to a data processing apparatus connected to the copying machine, and perform advanced editing by utilizing an application software of the data processing apparatus having an advanced function and a high processing capacity as well as an interface device having excellent operability, such as a display, a mouse, a keyboard and the like (e.g., Japanese Patent Application Laid-Open No. 2000-165639).

By these two methods, generation of high-quality copies of a paper document has conventionally been performed.

However, in a case where a document is converted to electronic data by a scanner, captured as image data, and an electronic document is generated, image quality correction that is unique to a paper document, e.g., skew correction, density adjustment and the like, is necessary. Moreover, there is a case in which an empty page is inserted (called inserting paper) to indicate a logical breakpoint of the document in the inputted paper document.

Furthermore, in the above-described conventional technique, assuming a case where a document on which post-processing such as stapling and punching has been performed is read by a scanner, converted to electronic data, and imported to a printing application program of a document processing apparatus, the imprint of stapling, punching or the like becomes shade, generating a stain on the document. It may be possible to consider performing image editing on the read document to remove such traces of post-processing performed by the printer. However, the user has to manually perform retouching on each page, and it is inconvenient for the user.

Furthermore, in a case where a paper document including plural chapters is read by a scanner, since the document is stored as one file, a user is unable to figure out the breakpoint of each chapter. The user has to manually separate each chapter after the document is imported to the printing application program, and this is inconvenient for the user.

Moreover, in a case of printing the electronic document data from the printing application program, there are many cases that a user wants to perform post-processing such as stapling or punching in chapter unit similar to the original paper document. However, the printing application program of the document processing apparatus cannot automatically reflect the post-processing setting such as stapling and punching on the printing condition, so that the user has to manually perform setting of the post-processing.

In order to solve the above-described problems of the conventional techniques, the object of the present invention is to provide a document processing apparatus and a document processing method for reading a document by a scanner and inputting the read data to a printing application program of a document processing apparatus, which can recognize setting of post-processing on the document or recognize a change in the head/tail orientation (position corresponding to a breakpoint of each chapter) and automatically perform segmentation (chapter division).

Furthermore, in order to solve the above-described problems of the conventional techniques, the object of the present invention is to provide a document processing apparatus and a document processing method for reading a document by a scanner and inputting the electronic data to a document processing apparatus, which can automatically reflect post-processing data such as stapling, punching or the like recognized by the scanner, data indicative of an orientation of the document and a head/tail orientation of the document as well as a stapling direction, on the electronic data.

### SUMMARY OF THE INVENTION

In order to achieve the above objects, a document processing apparatus according to the present invention has the following configuration.

According to the first aspect of the present invention, a document processing apparatus comprises
registration means for registering data indicative of post-processing setting, which has-been performed on a sheet document in page unit, as document setting of a generated electronic document, and
generation means for generating printing data by reflecting the registered document setting on the generated electronic document.

According to the second aspect of the present invention, a document processing apparatus comprises electronic document generation means for generating an electronic document based on image data of a sheet document, which is inputted by image input means in page unit,
determination means for recognizing, in units of consecutive pages, data indicative of post-processing setting which is performed on each page of the sheet document and determining whether or not the data indicative of post-processing setting has changed, and
chapter division means for recognizing a page, which is determined by the determination means that the data indicative of post-processing setting has changed, as a breakpoint of the inputted sheet document, and registering document setting of the electronic document to perform chapter division at the page.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute part of the specification, illustrate embodiments of the invention and, together with the description, serve to explain the principles of the invention.

FIG. 1 is a block diagram showing an example of a software construction of a stand-alone-type document processing system according to an embodiment of the present invention;

FIG. 2 is a block diagram showing an example of a hardware construction which realizes the document processing system according to the embodiment;

FIG. 3 is a view showing an example of a book file construction;

FIGS. 4A and 4B are views showing a list of book attributes;

FIG. 5 is a view showing a list of chapter attributes;

FIG. 6 is a view showing a list of page attributes;

FIG. 7 is a flowchart describing an example of a book file opening procedure;

FIG. 8 is a view showing an example of a user interface screen when a new book file is opened;

FIG. 9 is a view showing an example of a user interface screen when an existing book file is opened;

FIG. 10 is a flowchart describing an example of a procedure for importing an electronic document file to a book file

FIG. 11 is a flowchart describing a procedure for converting application data to an electronic document file shown in step S801 in FIG. 10;

FIG. 12 is a diagram showing an example of a data structure used in printing or displaying;

FIG. 13 is a block diagram showing an example of a software construction of a client-server-type document processing system;

FIG. 14 is a view showing an example of a dialogue window where setting is performed for the entire document which is the highest layer of the data structure;

FIG. 15 is a view showing an example of a dialogue window where setting is performed for a chapter which is a medium layer of the data structure;

FIG. 16 is a view showing an example where a unique attribute is set in the dialogue window shown in FIG. 15;

FIG. 17 is a view showing an example of a dialogue window where setting is performed for a page which is the lowest layer of the data structure;

FIG. 18 is a view showing an example of changing the set value in the dialogue window shown in FIG. 17;

FIG. 19 is a view showing a display example in a case where setting unique to the chapter or page is performed;

FIG. 20 is a block diagram showing a construction of a document processing system and a document printing apparatus which realize the present invention;

FIG. 21 is a flowchart describing an overall procedure for realizing the present invention;

FIG. 22 is a flowchart showing a procedure for reflecting the setting of stapling or punching, orientation of the document, and stapling direction;

FIG. 23A is a flowchart showing a procedure for correcting the head/tail orientation;

FIG. 23B is a view showing an example of an interface screen for correcting setting of the head/tail orientation;

FIG. 24 is a flowchart showing a procedure for performing chapter division at a position where post-processing is changed;

FIG. 25 is a flowchart showing a procedure for reflecting the setting in accordance with the capacity of a document printing apparatus;

FIG. 26 is a view showing an example of a dialogue window where a user makes determination of whether or not to reflect post-processing data;

FIG. 27 is a list of post-processing data to be transmitted to a document processing apparatus, which is recognized at the time of scanning a paper document;

FIG. 28 is a view showing an example of a dialogue window where a user makes determination of whether or not to perform chapter division;

FIG. 29 is a flowchart describing a procedure for setting the stapling direction and single-sided or double-sided printing in accordance with post-processing data;

FIG. 30 is a view showing an example of a user interface screen for selecting a processing option in data import;

FIG. 31 is a view showing an example of a user interface screen for designating chapter division of a document; and

FIG. 32 is a view showing an example of a user interface screen for selecting an option in the chapter division of a document.

### DETAILED DESCRIPTION OF THE PREFERRED EMBODIMENTS

Preferred embodiments of the present invention will now be described in detail in accordance with the accompanying drawings.

Overview of Document Processing System According to Present Embodiment

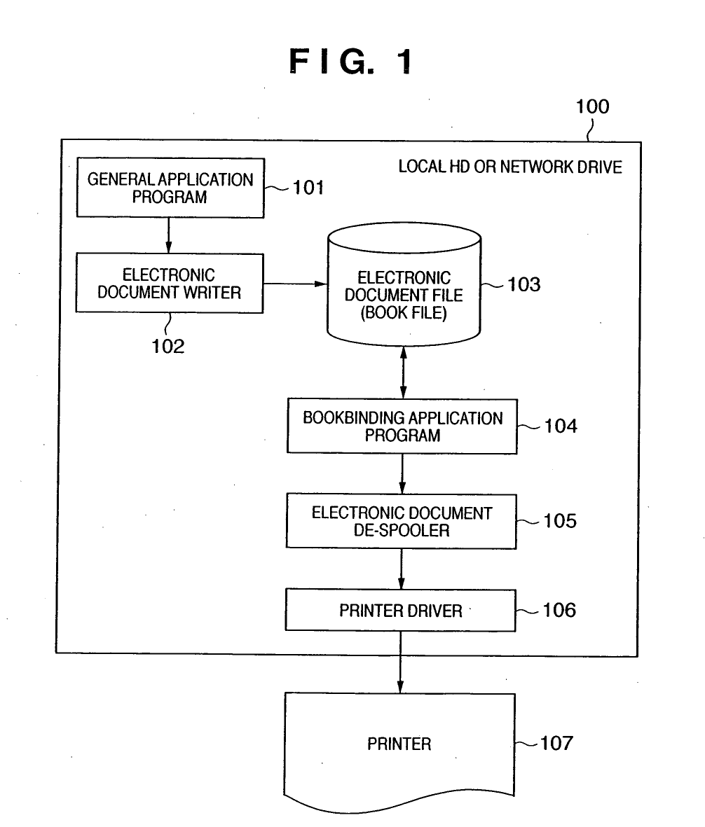

An overview of a document processing system, which is the first embodiment of the present invention, is described with reference to FIGS. 1 to 13. In the document processing system, a data file generated by a general application program is converted to an electronic document file by an electronic document writer. A bookbinding application program provides a function for editing the electronic document file. Note that although this example separately shows the general application program, electronic document writer, bookbinding application program, and electronic document de-spooler to clarify each of the functions, a package provided to the user is not limited to this, but an application program or a graphic engine combining these functions may be provided. Hereinafter, details of the functions will be described.

Software Construction of Document Processing System According to Present Embodiment

FIG. 1 shows a software construction of the document processing system according to this embodiment.

The document processing system is realized by a digital computer 100 (hereinafter referred to as a host computer (document processing apparatus)) which is a preferred embodiment of the document processing apparatus (data processing apparatus) according to the present invention. A general application program 101 provides functions such as word processing, spreadsheet, photo-retouching, drawing or painting, presentation, text editing and the like. It has a printing function for an OS. The application program utilizes a predetermined interface (generally called a GDI) provided by an operating system (OS) for printing the application data, e.g., generated document data, image data or the like.

More specifically, to print the generated data, the application program 101 transmits a predetermined output command (called a GDI function) having an OS-dependent format to an output module of the OS which provides the interface. The output module which receives the output command converts the command to a format processable by the output device, e.g., a printer, and outputs the converted command (called a DDI function). Since the format processable by the output device is different for each type of device, the manufacturer and model of the device, a device driver is provided for each device. The OS performs conversion of the command utilizing the device driver to generate printing data, and encloses the printing data with Job Language (JL) to generate a printing job. In a case where Windows by Microsoft Corp. is used as an OS, a module called Graphic Device Interface (GDI) corresponds to the output module.

An electronic document writer 102, which is an improved version of the aforementioned device driver, is a software module provided for realizing the document processing system. Note that the electronic document writer 102 is not intended for a particular output device, and it converts an output command to a format processable by the bookbinding application program 104 or a printer driver 106 which will be described later. The format of the output command converted by the electronic document writer 102 (hereinafter referred to as an electronic document format) may be of any format as long as the document can be expressed with a detailed format in page unit. Among the virtual standard formats, for instance, the PDF format or SVG format by Adobe Systems Inc. may be employed as an electronic document format.

In a case where the electronic document writer 102 is used by the application program 101, the electronic document writer 102 is designated as a device driver for output, and then printing is executed. It should be noted that the electronic document file generated by the electronic document writer 102 does not have a complete format as an electronic document file. Therefore, under the control of the bookbinding application program 104 which designates the electronic document writer 102 as a device driver, the application data is converted to an electronic document file. The bookbinding application program 104 turns the incomplete electronic document file which is newly generated by the electronic document writer 102 into an electronic document file having a format that will be described later. Hereinafter, when it is necessary to clearly distinguish the two files, the file generated by the electronic document writer 102 will be referred to as an electronic document file, and the electronic document file whose structure is given by the bookbinding application program will be referred to as a book file. When it is not necessary to distinguish the two files, the document file generated by the application program, electronic document file, and book file are all referred to as a document file (or document data).

As described above, by designating the electronic document writer 102 as a device driver and printing the data by the general application program 101, the application data is converted to the electronic document format having a page unit that is defined by the application program 101 (hereinafter referred to as a logical page or a document page), and stored as the electronic document file 103 in a storage medium, e.g., a hard disk. Note that the hard disk may be of a local drive of a computer realizing the document processing system according to the present embodiment, or in a case where the computer is connected to a network, the hard disk may be of a drive provided on the network.

The bookbinding application program 104 reads the electronic document file or book file 103, and provides a user with the function for editing the file 103. Note that the bookbinding application program 104 does not provide a function for editing the content of each page, but provides a function for editing a chapter or book structure configured with a page as a minimum unit, which will be described later.

To print the book file 103 edited by the bookbinding application program 104, an electronic document de-spooler 105 is started by the bookbinding application program 104. The electronic document de-spooler 105 is a program module installed in the computer along with the bookbinding application program 104, and is used for outputting rendering data to a printer driver at the time of printing a document (book file) using the bookbinding application program. The electronic document de-spooler 105 reads the designated book file from the hard disk, generates an output command that is compatible with the aforementioned output module of the OS for printing respective pages in the format described in the book file, and outputs the generated output command to the output module (not shown). In this stage, the driver 106 of the printer 107 used as an output device is designated as a device driver. The output module converts the output command, which is received by the designated printer driver 106 of the printer 107, to a device command which can be interpreted by the printer 107. Then, the device command is transmitted to the printer 107, and an image corresponding to the command is printed by the printer 107.

Hardware Construction of Document Processing System According to Present Embodiment

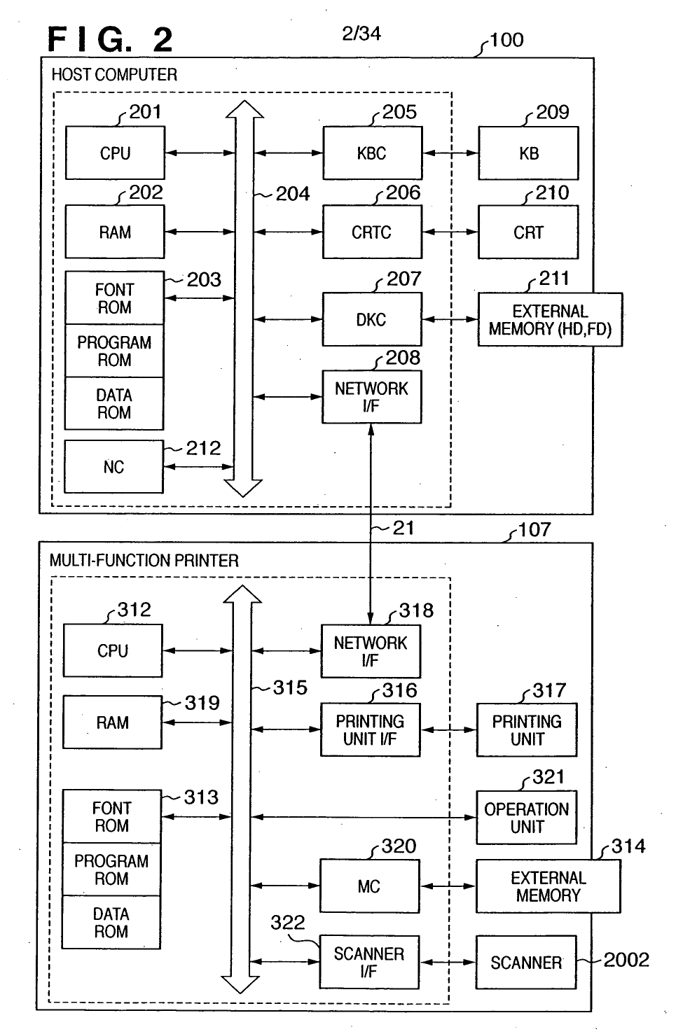

FIG. 2 shows a hardware construction of the document processing system according to this embodiment. Referring to FIG. 2, a host computer 100 comprises a CPU 201 which executes processing on a document including graphics, images, texts, charts (including spreadsheet) and so on based on a document processing program stored in program ROM of ROM 203 or an external memory 211. The CPU 201 comprehensively controls the respective devices connected to a system bus 204. In the program ROM of the ROM 203 or in the external memory 211, an Operating System program or the like serving as a control program of the CPU 201 is stored. In the font ROM of the ROM 203 or in the external memory 211, font data used in the aforementioned document processing is stored. In the data ROM of the ROM 203 or in the external memory 211, various data used in the aforementioned document processing is stored. RAM 202 serves as a main memory and a work area of the CPU 201.

A keyboard controller (KBC) 205 controls key inputs from a keyboard 209 or a pointing device (not shown). A CRT controller (CRTC) 206 controls displaying of a CRT display (CRT) 210. A disk controller (DKC) 207 controls an access to the external memory 211, e.g., a floppy disk (FD) or the like, and the hard disk (HD) which stores a boot program, various application programs, font data, user files, edit files, a printer control command generation program (printer driver) or the like. A network I/F 208, which is connected to the printer 107 through a bi-directional interface 21, executes communication control for communication with the printer 107. An NC 212, which is connected to the network, executes communication control for communication with other devices connected to the network.

Note that the CPU 201 executes development (rasterizing) of an outline font in, e.g., display data RAM which is set in the RAM 202, enabling WYSIWYG on the CRT 210. Further, the CPU 201 opens various windows registered based on a command designated by a mouse cursor or the like (not shown) on the CRT 210 and executes various data processing. When printing is to be executed, a user opens a window related to print setting and performs setting related to the print processing method on the printer driver, including printer setting and printing mode selection.

The printer 107 is controlled by a CPU 312. The printer's CPU 312 outputs an image signal as output data to a printing unit (printer engine) 317, connected to a system bus 315, based on a control program stored in a program ROM of the ROM 313 or a control program stored in an external memory 314. In the program ROM of the ROM 313, a control program of the CPU 312 or the like is stored. In the font ROM of the ROM 313, font data used for generating the output data is stored. In a case where a printer does not have the external memory 314 such as a hard disk, in the data ROM of the ROM 313, data used by a host computer is stored.

The CPU 312 can communicate with the host computer through a network I/F 318 and can inform the host computer 100 of the data regarding the printer. RAM 319 serves as a main memory and a work area of the CPU 312. The memory capacity of the RAM 319 can be expanded by an optional RAM connected to an expansion port (not shown). Note that RAM 319 is used as an output data developing area, environment data storage area, NVRAM, or the like. Access to the aforementioned hard disk (HD) and the external memory 314, e.g., an IC card or the like, is controlled by a memory controller (MC) 320. The external memory 314, which is connected as an option, stores font data, an emulation program, form data and so on. In an operation panel 321, operation switches, LED indicators and so on are arranged.

The aforementioned external memory 314 is not limited to one, but a plurality of memories may be provided. An option card in addition to the built-in font, and a plurality of external memories storing a program for interpreting a printer control language of a different language system may be connected. Furthermore, NVRAM (not shown) may be provided to store printer mode setting data from the operation panel 321.

Format of Electronic Document Data

Before details of the editing application program 104 are described, a data format of a book file is explained. A book file has three-layered structure, simulating a book in a paper medium. The highest layer called a “book” simulates one whole book, and attributes related to the entire book are defined. The medium layer below the book layer, which corresponds to a chapter of a book, is called a “chapter”. Attributes can be defined for each chapter. The lowest layer called a “page” corresponds to each page defined by the application program. Attributes can be defined for each page as well. One book may include plural chapters. One chapter may include plural pages.

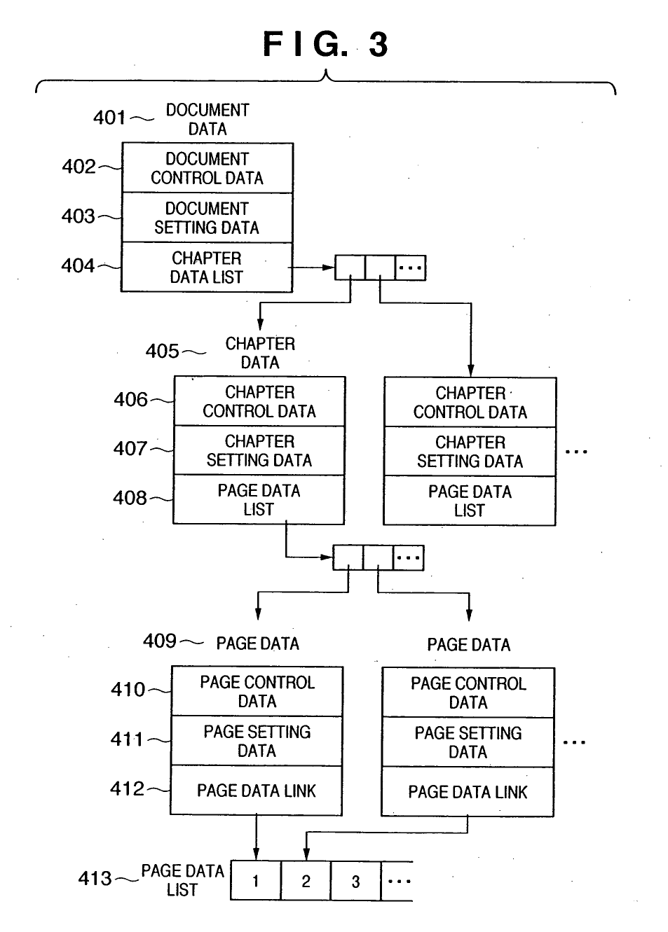

FIG. 3 diagrammatically shows an example of a book file format. The book, chapter, and page of the book file are shown by the respective nodes. One book file includes one book. Since the book and chapter are the concept for defining the structure of the book, they include, as their substantiveness, a defined attribute value and a link to the lower layer. The page includes, as its substantiveness, data for each page outputted by the application program. Therefore, the page includes the actual document page (document page data) and a link to each document page data, in addition to an attribute value. Note that there are cases where the printing page outputted to a paper medium or the like includes plural document pages. This structure is not indicated by links, but indicated by an attribute in each layer of the book, chapter, and page.

In FIG. 3, since the book file is not necessarily one complete book, the “book” is generalized as a “document”.

In the highest layer, document data 401 is held. The document data 401 is broadly divided into three parts 402 to 404. Document control data 402 holds data, e.g., a path name in the file system of the document file. Document setting data 403 holds layout data, e.g., a page layout, and printer's function setting data, e.g., stapling, which corresponds to an attribute of the book. A chapter data list 404 holds a group of chapters, which constitute the document, in the form of list. The chapter data list 404 stores chapter data 405.

The chapter data is also broadly divided into three parts 406 to 408. Chapter control data 406 holds data, e.g., a name of the chapter. Chapter setting data 407 holds a page layout that is unique to the chapter and stapling data, which corresponds to an attribute of the chapter. By holding setting data for each chapter, it is possible to generate a document having a complicated layout, e.g., a document having 2-UP layout for the first chapter and 4-UP layout for other chapters. A page data list 408 holds a group of document pages, which constitute each chapter, in the form of list. The page data list 408 stores page data 409.

The page data is also broadly divided into three parts 410 to 412. Page control data 410 holds data, e.g., a page number displayed on the tree. Page setting data 411 holds data, e.g., a page rotation angle, page arrangement/position data, which corresponds to a document page attribute. A page data link 412 holds document data corresponding to the page. In this example, the page data 409 does not directly hold the document data but holds the link data 412 only, and actual document data is held by the page data list 413.

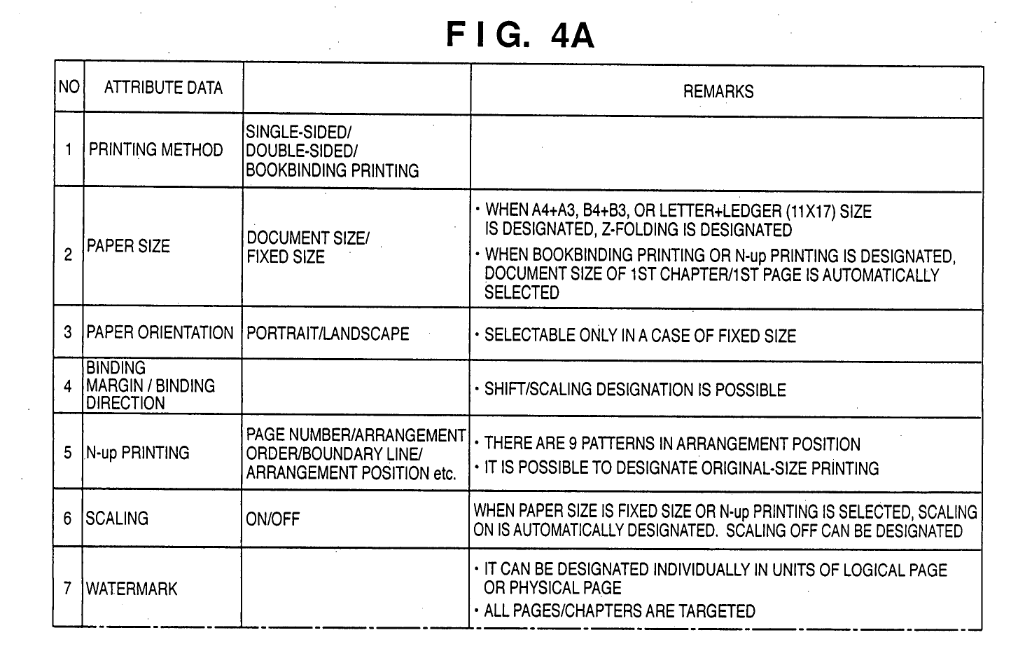

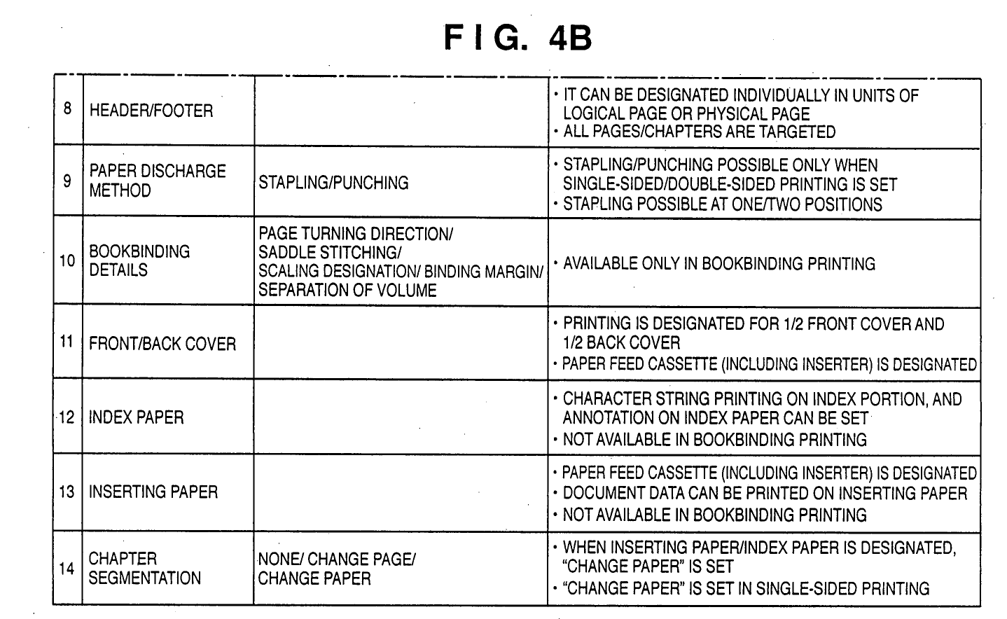

FIGS. 4A and 4B are a list showing an example of book attributes. With regard to an item that can be defined also in the lower layer, normally the attribute value of lower layer is prioritized. Therefore, with respect to an item included only in the book attribute, a value defined in the book attribute is effective throughout the entire book. However, with respect to an item that overlaps with the lower layer, the value serves as a default value in case where no attribute value is defined in the lower layer. However, in this embodiment, it is possible to select whether or not to prioritize the attribute value of lower layer, as will be described later. Note that each item shown in FIGS. 4A and 4B does not correspond to one specific item, but may include plural related items.

Items unique to the book attributes are: printing method, bookbinding details, front cover/back cover, index paper, inserting paper, and chapter segmentation. These are items defined throughout the book. For the printing method attribute, three values: single-sided printing, double-sided printing, and bookbinding printing can be designated. The bookbinding printing is a method which performs printing in the format so that a bundle of a designated number of paper is folded in half and bound. When bookbinding printing is designated, a page turning direction, the number of pages in the bundle, and so on can be designated as detailed attributes of bookbinding.

The front cover/back cover attribute includes designation to add a piece of paper for a front cover or a back cover and designation to print contents on the added paper, when the electronic document file subjected to bookbinding is printed. The index paper attribute includes designation to insert a piece of index paper which has an index (ear) prepared separately by the printer to indicate chapter segmentation, and designation to print contents on the index (ear) portion. These attributes are effective when the printer comprises an inserter having a function to insert a piece of paper prepared in addition to regular printing paper to a desired position, or when plural paper-feed cassettes are available. This also applies to the inserting paper attribute.

The inserting paper attribute includes designation to insert paper supplied from an inserter or a paper-feed cassette to indicate chapter segmentation, and designation of a paper-feed source in a case of inserting the paper.

The chapter segmentation attribute designates whether or not to use a new piece of paper or a new printing page or to perform no operation at a breakpoint of each chapter. When single-sided printing is performed, using a new piece of paper is the same meaning as using a new printing page. When double-sided printing is performed, if the attribute “use a new piece of paper” is designated, consecutive chapters are not printed on one piece of paper, but if the attribute “use a new printing page” is designated, consecutive chapters are printed on the front and back side of the paper.

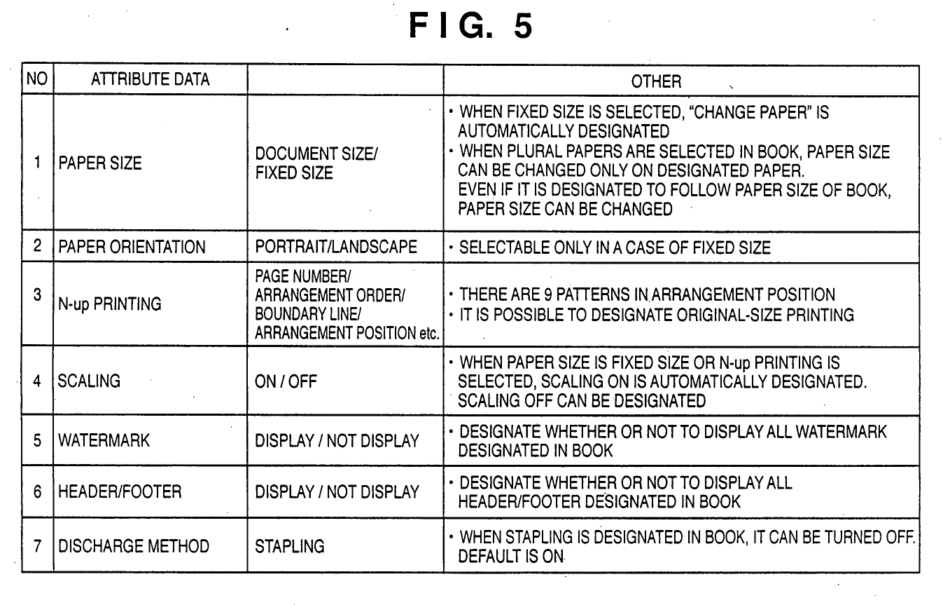

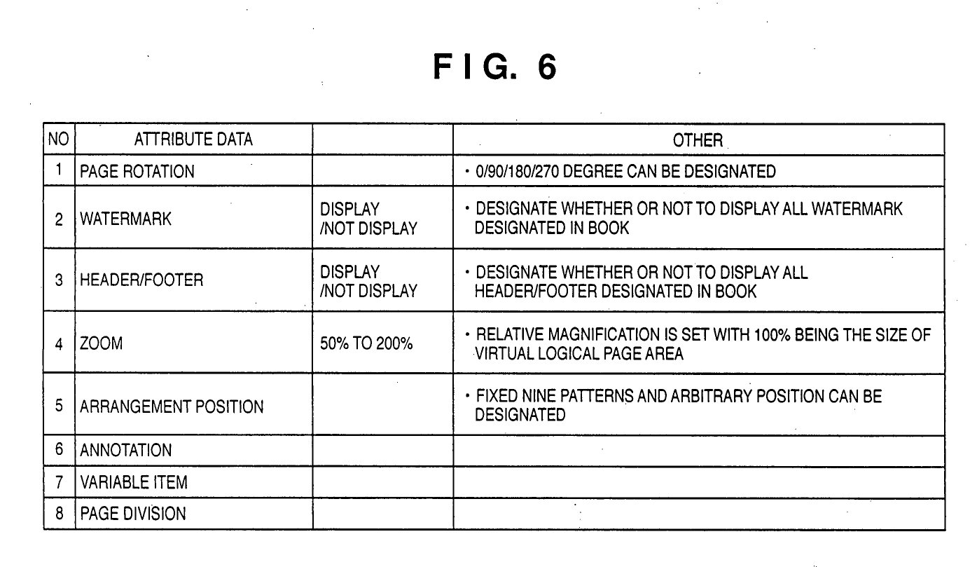

FIG. 5 is a list showing an example of the chapter attributes (chapter setting data 407). FIG. 6 is a list showing an example of page attributes (page setting data 411). The relation between a chapter attribute and a page attribute is the same as the relation between a book attribute and an attribute of the lower layer.

With respect to chapter attributes, there is no item unique to the chapter, and all items overlap with the book attributes. Therefore, if a definition in the chapter attribute and a definition in the book attribute differ, normally the value defined by the chapter attribute has a priority. However, in this embodiment, it is possible to select whether or not to prioritize the attribute value of lower layer, as will be described later.

Items common to the book attributes and chapter attributes are five items: paper size, paper orientation, N-up printing designation, scaling, and paper discharge method. Among these items, the N-up printing designation attribute designates the number of document pages to be printed in one page. An arrangement such as 1×1, 1×2, 2×2, 3×3, 4×4 and the like can be designated. The paper discharge method attribute designates whether or not to perform stapling on the discharged paper. This attribute is effective when the printer has a stapling function.

Items unique to the page attributes are: page rotation, zooming, arrangement designation, annotation, page division and the like. The page rotation attribute designates a rotation angle at the time of arranging the document page on a printing page. The zooming attribute designates an enlargement/reduction rate of the document page. The enlargement/reduction rate is designated with an assumption that the size of the virtual logical page area is 100%. The virtual logical page area is an area of one document page in a case where the document page is arranged in accordance with N-up designation or the like. In a case of 1×1, the virtual logical page area is an area corresponding to one printing page. In a case of 1×2, the virtual logical page area is an area where each side of one printing page is reduced to about 70%.

Attributes common to the book, chapter, and page are a watermark attribute and a header/footer attribute. The watermark is an image or a character string which is separately designated and printed on top of the data generated by an application program. The header/footer is a watermark printed on the top space or bottom space of each page. For the header/footer, an item that can be designated by a variable, e.g., a page number, a date and so on, is prepared. Note that contents that can be designated by the watermark attribute and the header/footer attribute are common to the chapter and page, but are different in the book. In the book, contents of the watermark and header/footer can be set, and the way the watermark and header/footer is printed can be designated throughout the book. However, in the chapter or page, it is possible to designate whether or not to print the watermark or header/footer designated in the book.

Operation Procedure of Document Processing System According to Present Embodiment

Book File Generation Procedure

A book file has a structure and a content described above. A procedure for generating a book file by the bookbinding application program 104 and the electronic document writer 102 is described. Book file generation is realized as part of book file editing operation performed by the bookbinding application program 104.

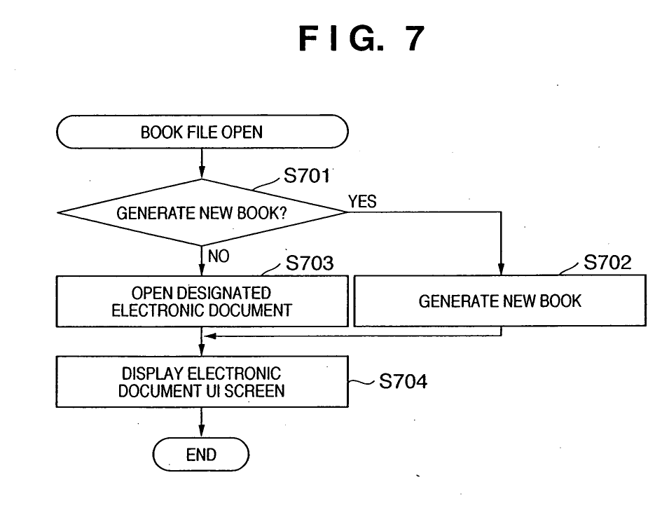

FIG. 7 is a flowchart describing a book file opening procedure performed by the bookbinding application program 104.

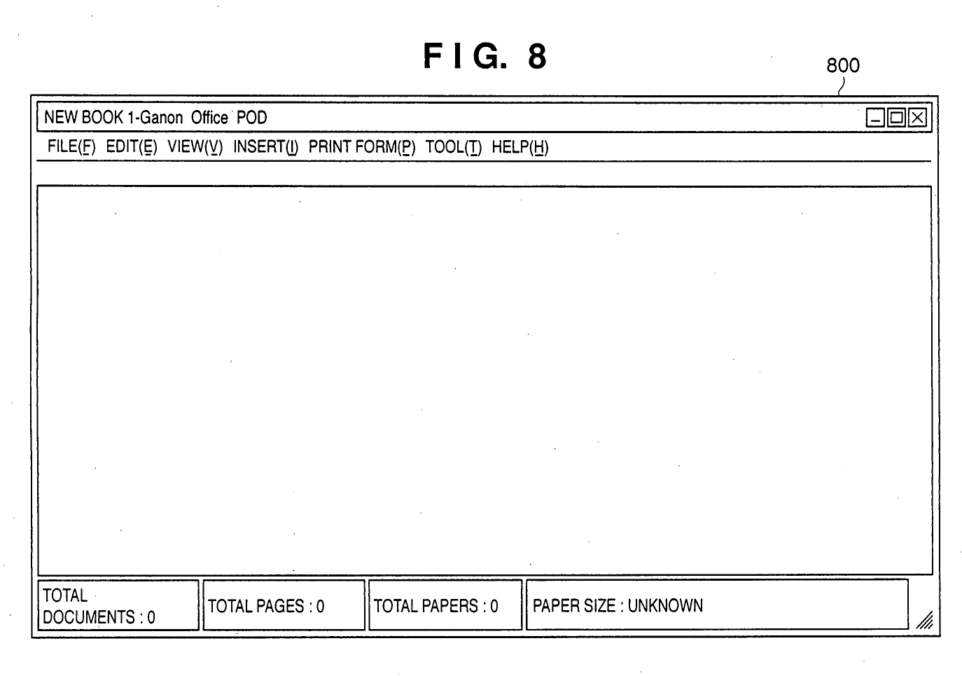

First, it is determined whether or not the book file to be opened is a new file to be generated or an existing file (step S701). In a case of a new file, a book file having no chapter is newly generated (step S702). The book file newly generated only has the book node 401 shown in FIG. 3, and has no link to the chapter node. For book attributes, a predetermined set of attributes is adopted. Then, a user interface (UI) screen for editing the new book file is displayed (step S704). FIG. 8 shows an example of the UI screen displayed when a new book file is generated. In this example, since the book file has no substantial content, there is nothing displayed on the UI screen 800.

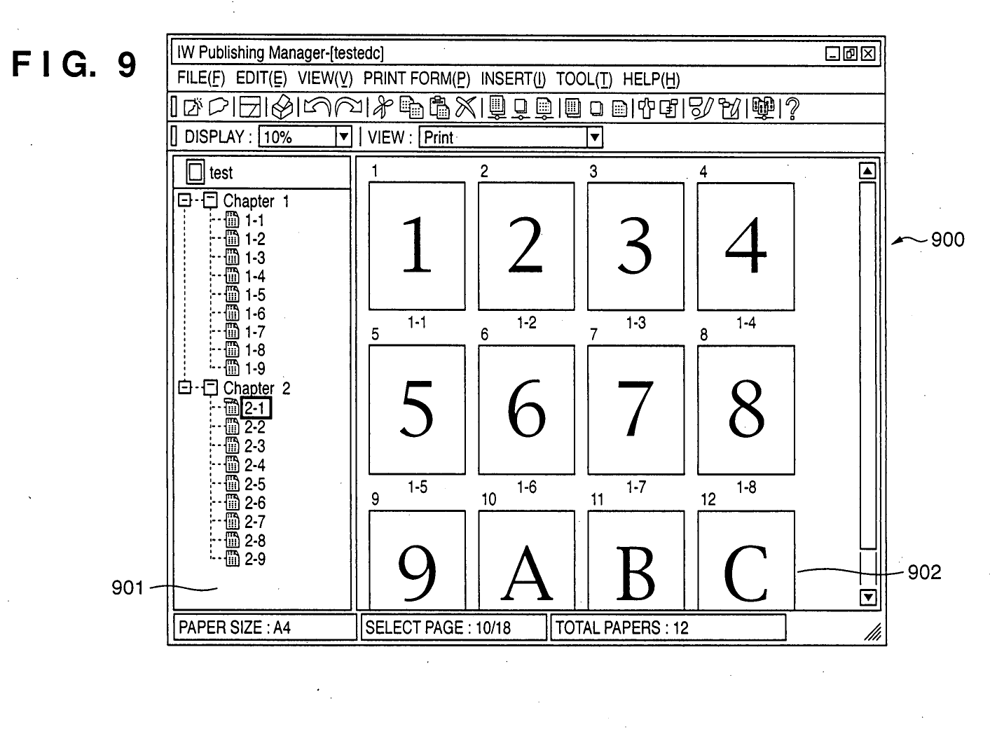

Meanwhile, if an existing book file is found, the designated book file is opened (step S703) and displayed on the user interface (UI) screen in accordance with the structure, attribute, and content of the book file. FIG. 9 shows an example of the UI screen. The UI screen 900 includes a tree portion 901 indicative of the book structure, and a preview portion 902 displaying a printed state of the book file. In the tree portion 901, chapters included in the book and pages included in each chapter are displayed in a manner that the tree structure shown in FIG. 3 is clarified. The pages displayed on the tree portion 901 are document pages. In the preview potion 902, the content of the printing page is displayed in a reduced size. The order of displaying reflects the book structure.

To the open book file, application data that has been converted to an electronic document file by the electronic document writer 102 can be added as a new chapter. This function is called an electronic document import function. By electronically importing the document to the book file newly generated by the procedure shown in FIG. 7, the book file becomes substantive. This function is started by performing drag-and-drop operation of the application data on the screen shown in FIG. 8 or 9.

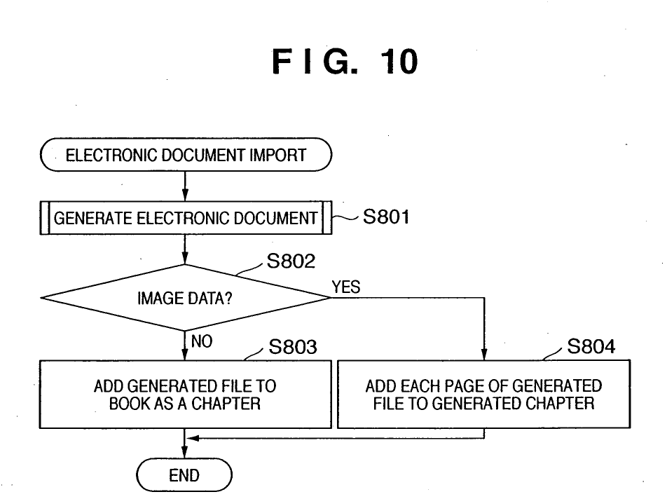

FIG. 10 is a flowchart describing an example of a procedure for importing an electronic document.

First, an application program which has generated the designated application data is started. The electronic document writer 102 is designated as a device driver and the application data is printed, thereby being converted to electronic document data (step S801). Upon conversion, it is determined whether or not the converted data is image data (step S802). The determination is made based on a file extension of the application data, if the Windows OS is used. For instance, if the file extension is “bmp”, the data is Windows bitmap data; if it is “Jpg”, the data is JPEG-compression data; and if it is “tiffs”the data is tiff-format image data. In a case where the data is such image data, it is possible to generate an electronic document file directly from the image data without starting the application program in step S801. Therefore, step S801 can be omitted.

If the data is not image data, the electronic document file generated in step S801 is added as a new chapter to the book of the open book file (step S803). For a chapter attribute, normally the value of the book attribute is given if the attribute is common to the book and chapter. If the attribute is not common, a predetermined value is set. However, in this embodiment, it is possible to select whether or not to prioritize the attribute value of lower layer, as will be described later.

In the case of image data, a new chapter is not added in principle, but each document page of the electronic document file generated in step S801 is added to a designated chapter (step S804). Note if the book file is a newly generated file, a new chapter is generated and each page of the electronic document file is added as a page that belongs to the new chapter. For a page attribute, normally the attribute value of the upper layer is adopted if the attribute is common. With respect to an attribute defined in the application data and inherited to the electronic document file, this attribute value is given. For instance, in a case where N-up designation is made in the application data, this attribute value is inherited. In the foregoing manner, a new book file is generated or a new chapter is added. Note, in this embodiment, it is possible to select whether or not to prioritize the attribute value of lower layer, as will be described later.

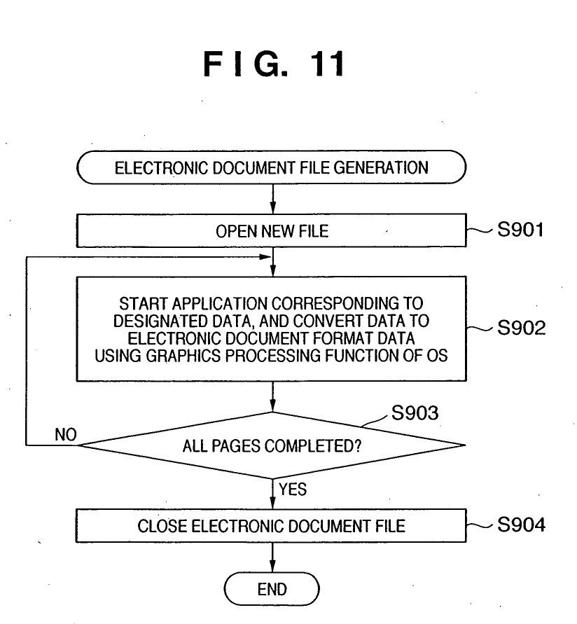

FIG. 11 is a flowchart describing a procedure for generating an electronic document file by the electronic document writer 102 in step S801 in FIG. 10.

First, a new electronic document file is generated and opened (step S901). An application program corresponding to the designated application data is started. The electronic document writer 102 is designated as a device driver, and an output command is transmitted to an output module of the OS. The output module converts the received output command into data having the electronic document format by the electronic document writer, and outputs the converted data (step S902). The output destination is the electronic document file opened in step S901. It is determined whether or not conversion for all the designated data has been completed (step S903). If the conversion has been completed, the electronic document file is closed (step S904). The electronic document file generated by the electronic document writer 102 is a file having substantive document page data shown in FIG. 3.

Editing Book File

In the above-described manner, a book file can be generated from application data. The following editing operation can be performed on a chapter and a page of the generated book file.
(1) newly add
(2) delete
(3) copy
(4) cut
(5) paste
(6) move
(7) change chapter name
(8) page renumber
(9) insert front cover page
(10) insert paper
(11) insert index paper
(12) layout page for each document page

Besides the above, an operation for canceling the edit performed once, and an operation for re-doing the canceled operation is possible. By these editing functions, it is possible to perform editing operation such as integration of plural book files, rearrangement of chapters or pages in a book file, deletion of a chapter or a page in a book file, layout change in a document page, insertion of paper or index paper, and so on. When such operation is performed, the operation result is reflected on the attributes shown in FIGS. 4A to 6 or the structure of the book file. For instance, if an operation for adding a new blank page is performed, a blank page is inserted to a designated place. The blank page is treated as a document page. Further, if a layout of a document page is changed, the change is reflected on the attributes such as the printing method, N-up printing, front cover/back cover, index paper, inserting paper, chapter segmentation and the like. The display and editing operation at the time of editing according to this embodiment will be described later in detail.

Outputting Book File

The ultimate goal of the book file, generated and edited in the above-described manner, is printout. When a user selects a file menu and designates printing on the UI screen 900 of the bookbinding application program shown in FIG. 9, the book file is printed from a designated output device. In this operation, first the bookbinding application program 104 generates a job ticket from the currently open book file, and transmits the job ticket to the electronic document de-spooler 105. The electronic document de-spooler 105 converts the job ticket to an output command of an OS, e.g., Windows GDI command, and transmits the command to an output module, e.g., GDI. The output module generates a command compatible with the device using the designated printer driver 106, and transmits the command to the device.

In other words, the graphic engine of the output module (not shown) loads the printer driver 106 provided for each printer from the external memory 211 to the RAM 202, and sets the output destination to the printer driver 106. The output module converts the received GDI (Graphic Device Interface) function to a DDI (Device Driver Interface) function, and outputs the DDI function to the printer driver 106. Based on the DDI function received from the output module, the printer driver 106 converts the command to a control command that can be recognized by the printer, e.g., PDL (Page Description Language). The printer control command is outputted as printing data to the printer 107 through the system spooler, which is loaded to the RAM 202 by the OS, and through the interface 21.

The aforementioned job ticket is data having a structure where a document page is the minimum unit. The structure in the job ticket defines the layout of the document page on a piece of paper. One job ticket is issued for one job. In the highest layer, there is a node called a document, where an attribute of the entire document, e.g., double-sided or single-sided printing, is defined. Under the document layer, there is a paper node, which includes attributes such as an identifier of paper to be used, designation of paper feeder of the printer, and the like. Each paper node includes the node for the sheet printed on the paper. One sheet corresponds to one piece of paper. A printing page (physical page) belongs to each sheet. In a case of single-sided printing, one physical page belongs to one sheet. In a case of double-sided printing, two physical pages belong to one sheet. To each physical page, a document page which is arranged on the physical page belongs. An attribute of the physical page includes a layout of the document page.

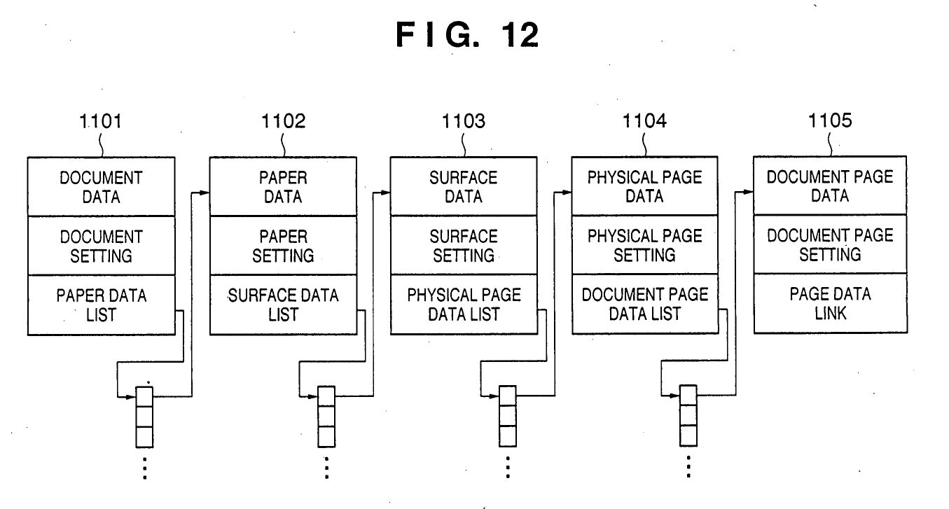

An example of the data structure of the job ticket is shown in FIG. 12. In printing data, a document is constructed with a group of papers. Each paper is constructed with two surfaces: a front surface and a back surface. Each surface has an area (physical page) where a document is laid out. Each physical page is constructed with a group of document pages, which is the minimum unit.

Numeral 1101 denotes data corresponding to the document, which is constructed with data related to the entire document and a list of paper data which constitutes the document. Paper data 1102 is constructed with data related to paper, e.g., a paper size, and a list of surface data arranged on the paper. Surface data 1103 is constructed with data unique to the surface, and a list of physical pages arranged on the surface. Physical page data 1104 is constructed with data, e.g., a size of the physical page and header/footer information, and a list of document pages which constitute the physical page.

The electronic document de-spooler 105 converts the above-described job ticket to an output command to be outputted to the output module.

Content of Preview Display

As described above, when a book file is opened by the bookbinding application program, the user interface screen 900 shown in FIG. 9 is displayed. In the tree portion 901, a tree indicative of the structure of the open book (hereinafter referred to as a book of interest) is displayed. In the preview portion 902, three ways of displaying methods are provided in accordance with user's designation. The first is a mode called a document view, in which a document page is displayed as it is. In the document view mode, the content of the document page that belongs to the book of interest is displayed in a reduced size. The display in the preview portion 902 does not reflect the layout of the document page. The second is a printing view mode. In the printing view mode, the preview portion 902 displays the document page while reflecting the designated layout of the document page. The third is a simple printing view mode. In the simple printing view mode, the content of the document page is not displayed, but only the designated layout of the document is displayed on the preview portion 902.

Construction of Other Document Processing System

The document processing system according to the above embodiment is a stand-alone type. Also in a server-client system which is an expanded system of the stand-alone type, a book file having a similar construction can be generated and edited by a similar procedure. Note that a book file and print processing are controlled by a server.

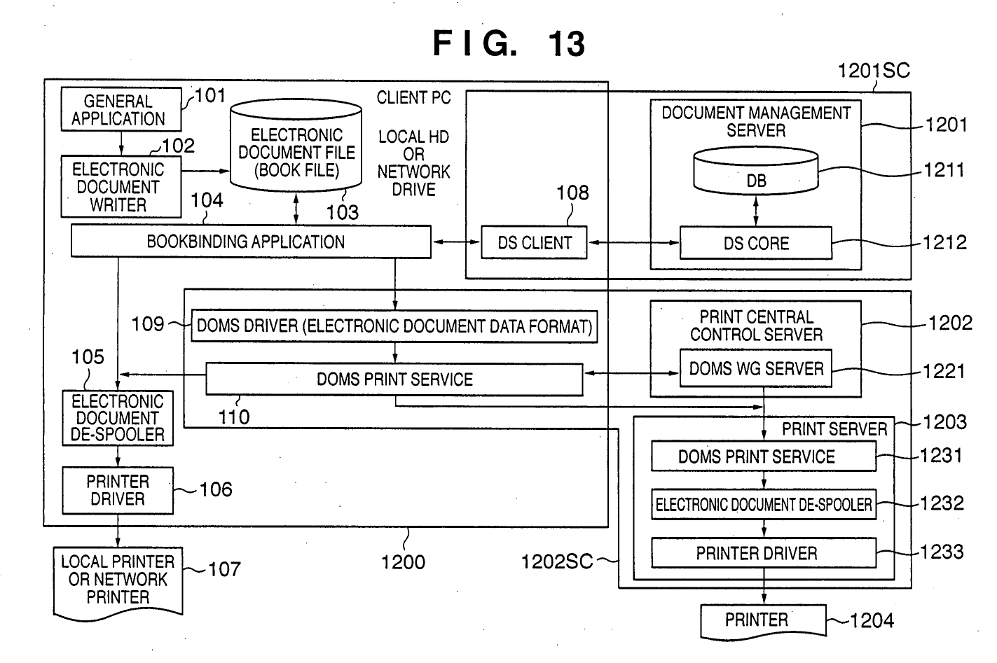

FIG. 13 is a block diagram showing a construction of a server-client-type document processing system. A client document processing system 1200 comprises a DOMS (Document Output Management Service) driver 109 serving as a client module, a DOMS print service module 110, and DS (Document Service) client module 108, in addition to the construction of the stand-alone-type system. To the client document processing system 1200, a document management server 1201, a print central control server 1202, and a print server 1203 are connected. These servers are normally connected to the client document processing system through a network. However, in a case where the server also functions as a client, they are connected through interprocess communication which simulates communication between networks. Note that in FIG. 13, although the document management server 1201 and the print central control server 1202 are connected to the client, there may be a case where only one of the servers exists in the network. If a connected server is the document management server, the document management server-client system 1201SC having a client module is added to the stand-alone-type document management system. If a connected server is the print central control server 1202, the print control server-client system 1202SC having a client module is added to the stand-alone-type document management system.

The document management server 1201 stores a book file generated and edited by the bookbinding application program 104. In a case of managing a book file by the document management server 1201, the book file is stored in a database 1211 of the document management server 1201 in place of or in addition to the local HD of the client PC. Storing and reading a book file between the bookbinding application program 104 and the document management server 1201 are performed through the DS client 108 and DS core 1212.

The print central control server 1202 controls printing of a book file stored in the client document management system 1200 or the document management server 1201. A printing request from the client is transmitted to a DOMS WG server module 1221 of the print central control server 1202 through the DOMS driver 109 and the DOMS print service module 110. In a case of performing printing by a printer of the client, the print central control server 1202 transmits electronic document data to the electronic document de-spooler 105 through the client's DOMS print service module 110. In a case of performing printing by the print server 1203, the print central control server 1202 transmits the electronic document data to the DOMS print service module 1231 of the print server 1203. The print central control server 1202 performs, e.g., security check for qualification of a user who has requested the printing of the stored book file, or stores printing logs. As described above, the document processing system can be realized as a stand-alone system or as a client-server system.

Editing Operation of Document Processing System According to Present Embodiment

FIG. 9 shows an operation screen of the bookbinding application program 104. The bookbinding application program can not only perform editing such as reshuffling the document page order, copying, deleting and the like, but also perform printer's function setting such as stapling, and perform printing by a designated printer. In the left area of FIG. 9, a tree view indicative of a structure of the document is displayed. The document is constructed with a group of chapters, and each chapter is constructed with a group of document pages. In the right area of FIG. 9, a printing preview of each page is displayed.

Attribute Setting of Document Processing System According to Present Embodiment

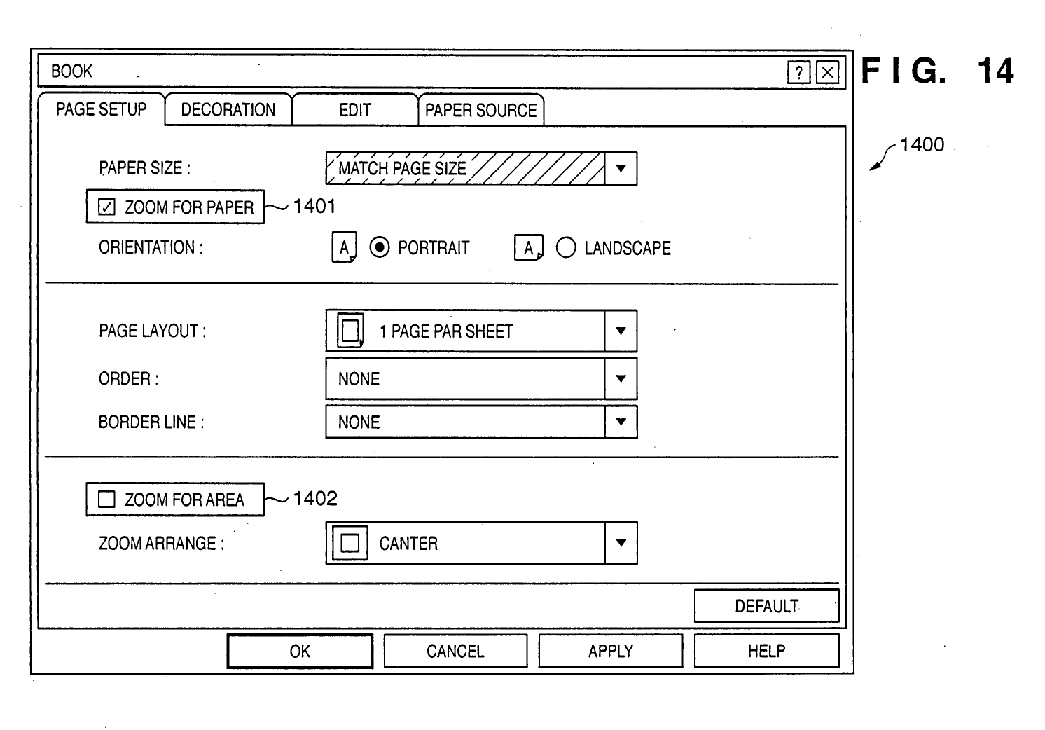

FIG. 14 shows a window 1400 called “Detailed Setting for Document”, provided by the bookbinding application program 104. In this window, document setting data 403 can be displayed/set. This window is started from the menu “Detailed Setting for Document” provided in the “Print Form” menu of the operation screen shown in FIG. 9, or from the button “Detailed Setting for Document” in the tool bar of the operation screen. In the window 1400, setting of an attribute that affects the entire document is performed. The window 1400 is constructed with four sheets: Page Setup, Decoration, Edit, and Paper Source. FIG. 14 shows a state where the Page Setup sheet is displayed. In the Page Setup sheet, setting that is mainly related to a layout is performed, and setting such as a paper size, an orientation of paper, and N-page printing can be designated. In the window 1400, check box control 1401 and 1402 related to zooming are provided.

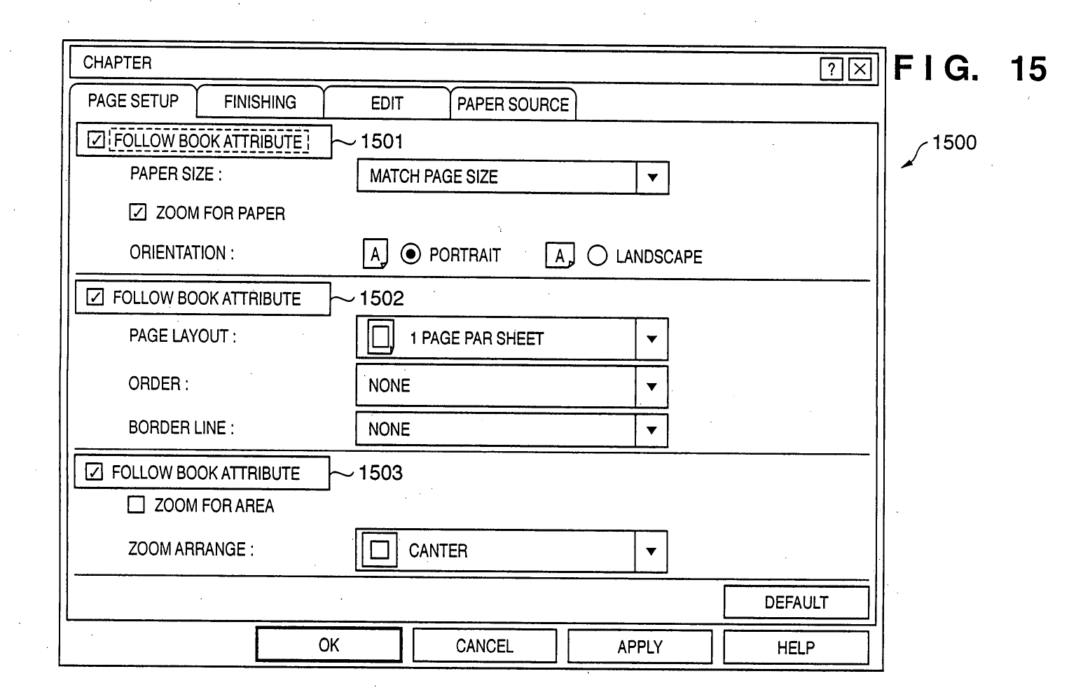

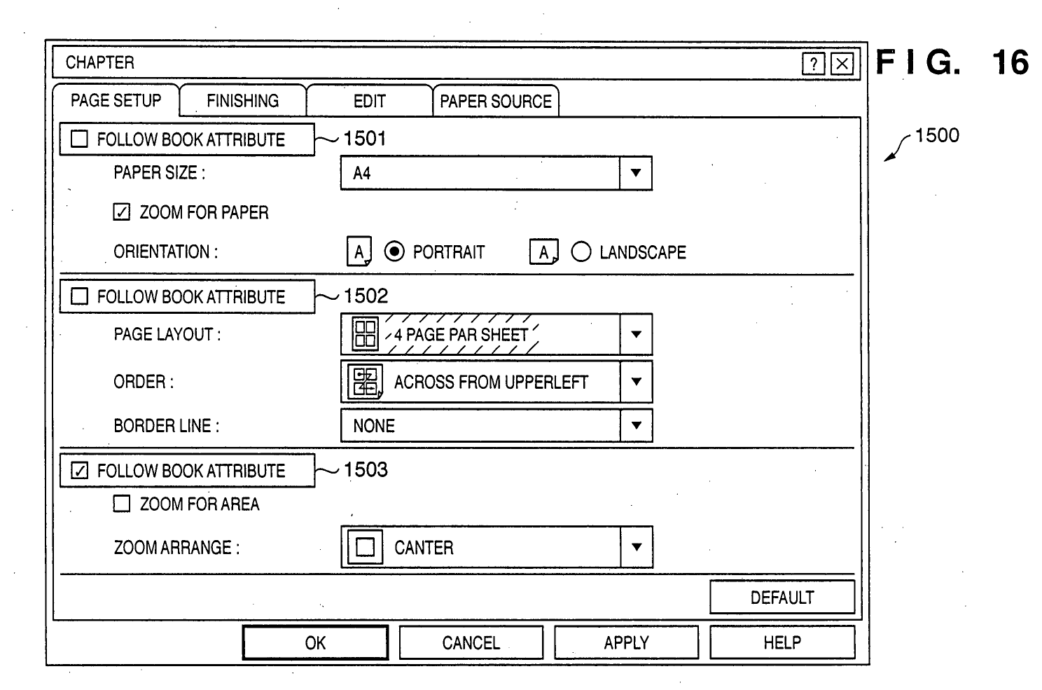

FIG. 15 shows a window 1500 called “Detailed Setting for Chapter”, provided by the bookbinding application program 104. In this window, chapter setting data 407 can be displayed/set. This window is started from the menu “Detailed Setting for Chapter” provided in the “Print Form” menu of the operation screen shown in FIG. 9, or from the button “Detailed Setting for Chapter” in the tool bar of the operation screen. In the window 1500, setting of an attribute unique to the chapter is performed. The window 1500 is constructed with four sheets: Page Setup, Decoration, Edit, and Paper Source. FIG. 15 shows a state where the Page Setup sheet is displayed. In the Page Setup sheet, setting that is mainly related to a layout unique to a chapter is performed, and setting such as a paper size, an orientation of paper, and N-page printing can be designated. With respect to the setting items that overlap in the window 1400 and window 1500, check box control 1501, 1502, and 1503 called “Follow Book Attribute” are provided. If the check box is ticked, the set value in the document is applied to the chapter. The case where the check box is not ticked will be described later with reference to FIG. 16. The setting unique to a chapter is categorized into two types. One is a setting item that is applicable only in a chapter. The other is a case where the chapter layer has a unique set value that is different from the upper document layer.

FIG. 16 shows a state where the check box control 1501 and 1502 are not ticked in the window 1500 shown in FIG. 15. In this case, since paper size A4 is designated for this chapter, the pages constituting the chapter are printed in A4-size paper even though A3-size paper is designated for the document. With respect to the layout, 4-page-per-sheet layout is designated for this chapter even though 1-page-per-sheet layout is designated for the document. With respect to the “zoom arrange”, since the check box is ticked, the set value of the document in the upper layer is adopted as a set value for this chapter.

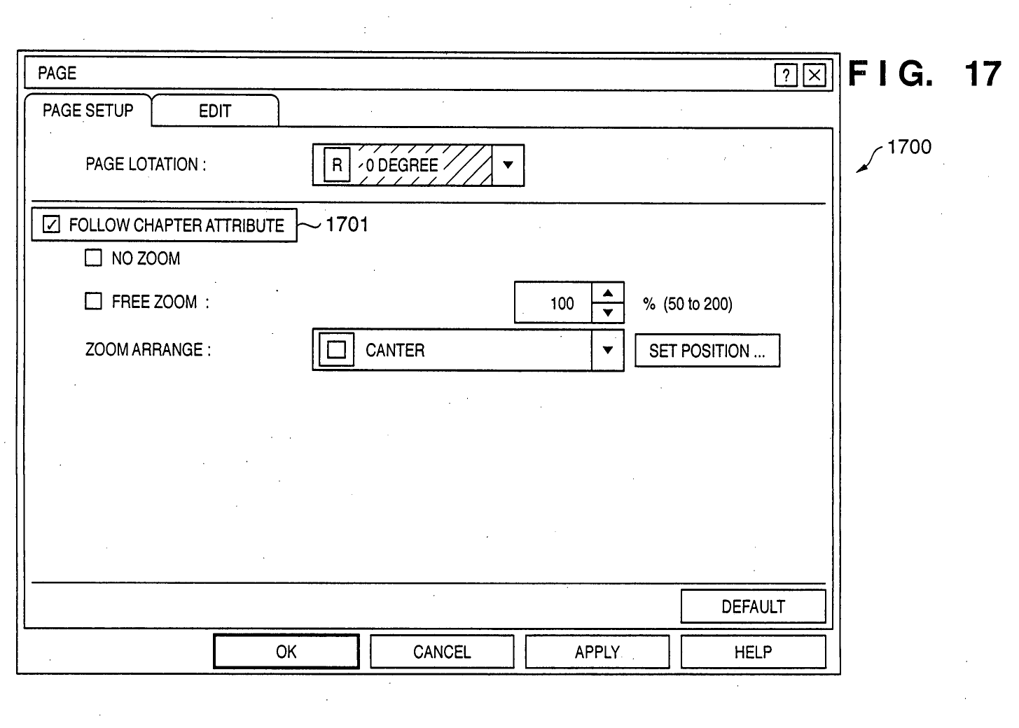

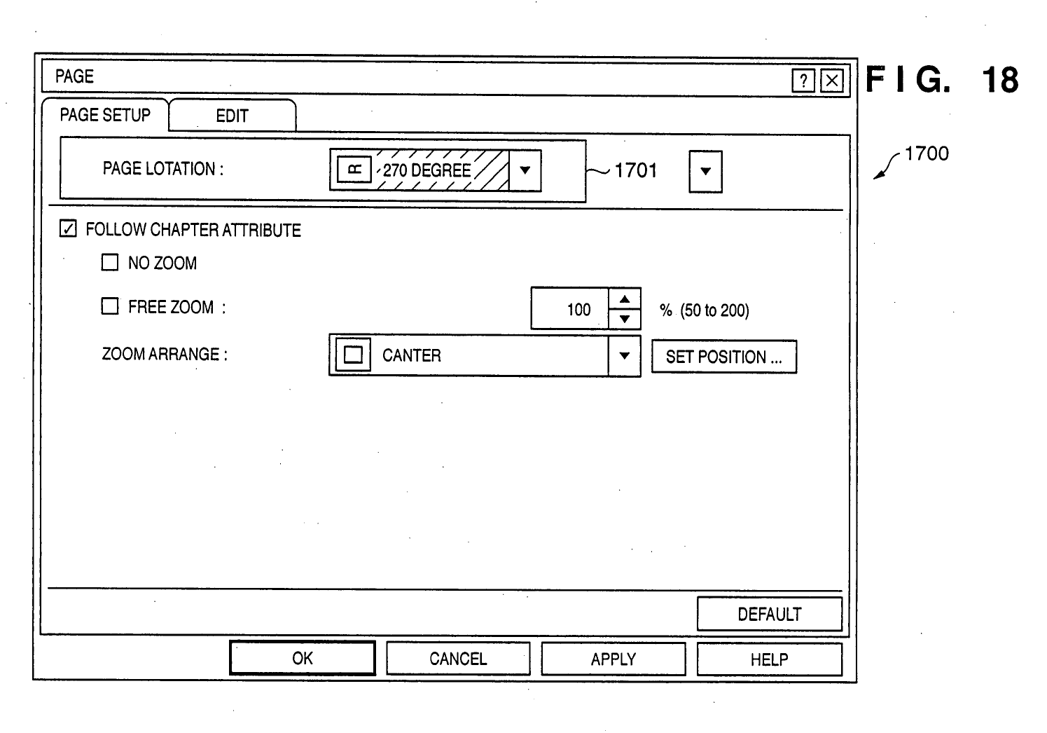

FIG. 17 shows a window 1700 called “Detailed Setting for Page”, provided by the bookbinding application program 104. In this window, page setting data 411 can be displayed/set. This window is started from the menu “Detailed Setting for Page” provided in the “Print Form” menu of the operation screen shown in FIG. 9, or from the button “Detailed Setting for Page” in the tool bar of the operation screen. In the window 1700, setting of an attribute unique to the page is performed. The window 1700 is constructed with two sheets: Page Setup and Edit. FIG. 17 shows a state where the Page Setup sheet is displayed. In the Page Setup sheet, setting that is mainly related to a layout unique to a page is performed, and setting such as a rotation angle, scaling rate and the like at the time of arranging the document page can be designated. With respect to the setting items that overlap in the window 1500 and window 1700, a check box control 1701 called “Follow Chapter Attribute” is provided. If the check box is ticked, the set value in the chapter is applied to the page. The case where the check box is not ticked will be described with reference to FIG. 18.

FIG. 18 shows a state where the Page Rotation setting is changed in the window 1700 shown in FIG. 17. In the control box 1701, page rotation is set to rotate the document page in a way that the topside of the page is laid out as the left side. With respect to this item, there is no check box “Follow Chapter Attribute”, in other words, there is no overlapping item in the Chapter and Document. Therefore, the setting displayed in this window is always the set value for the page. In a case where the check box 1701 is ticked, for instance, the item “Zoom Arrange”, which is an overlapping setting item for the chapter, adopts the set value for the chapter as the set value for the page. In the chapter, if the check box “Follow Book Attribute” is ticked with respect to the corresponding item “Zoom Arrange”, the set value for the document is adopted as a set value for the chapter. Ultimately, the set value for the document is adopted as a set value for the page. In the chapter, if the check box is not ticked, it means that the chapter has a unique set value. Therefore the set value unique to the chapter is adopted as a set value for the page.

Note that the check box control data set in the above-described setting screen may be stored in a dedicated storage area, but is preferably stored in the setting data area shown in FIG. 3 as one of the attributes. In this case, an area for storing the check box control data is added to FIGS. 5 and 6.

Displaying Document Edit of Document Processing System According to Present Embodiment

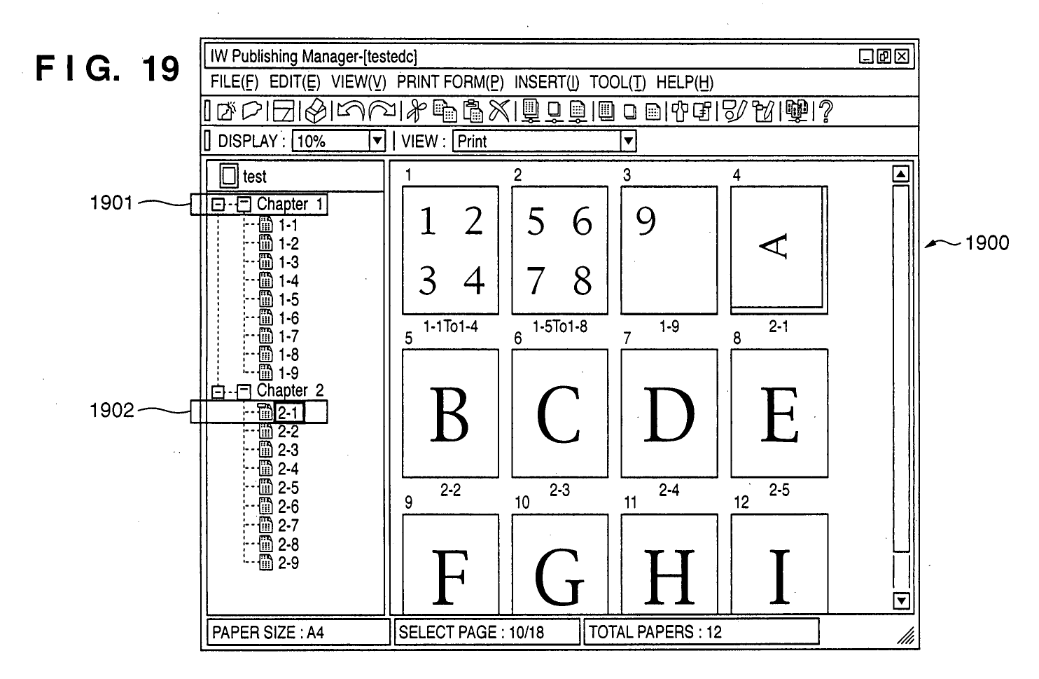

FIG. 19 shows a display form of the application program in a case where the set value for the upper layer is not adopted for the lower layer with respect to an overlapping setting item, in other words, the check boxes 1501 and 1701 are not ticked.

In FIG. 19, the document consists of two chapters, and each chapter has 9 pages of document data. In the displayed example, the first chapter is set in 4UP layout (also referred to as 4 in 1), and rotation is designated for the first page of the second chapter (the 10th page of the entire document). In pages 1 to 3 shown in the preview portion on the right side, four document pages are arranged in each page. In page 4, the character “Aw is rotated. The display form of the tree view in which unique setting is performed on the chapter and page is now described. The icon 1901 representing the first chapter is changed to indicate that chapter-unique setting is performed. The icon 1902 representing the first page of the second chapter is also changed to indicate that a special setting is performed on this page.

Document Setting Utilizing Post-Processing Data in Document Processing Apparatus

This embodiment provides document processing for inputting paper document, which is read by an image reading apparatus (a stand-alone scanner or a multi-function apparatus comprising input/output functions), comprising a host computer and a scanner unit connected through a bi-directional interface, as an electronic document (book file) to be handled by the bookbinding application program 104. Hereinafter, document processing for converting an image file, read from a paper document, to a book file is described.

Option in Importing

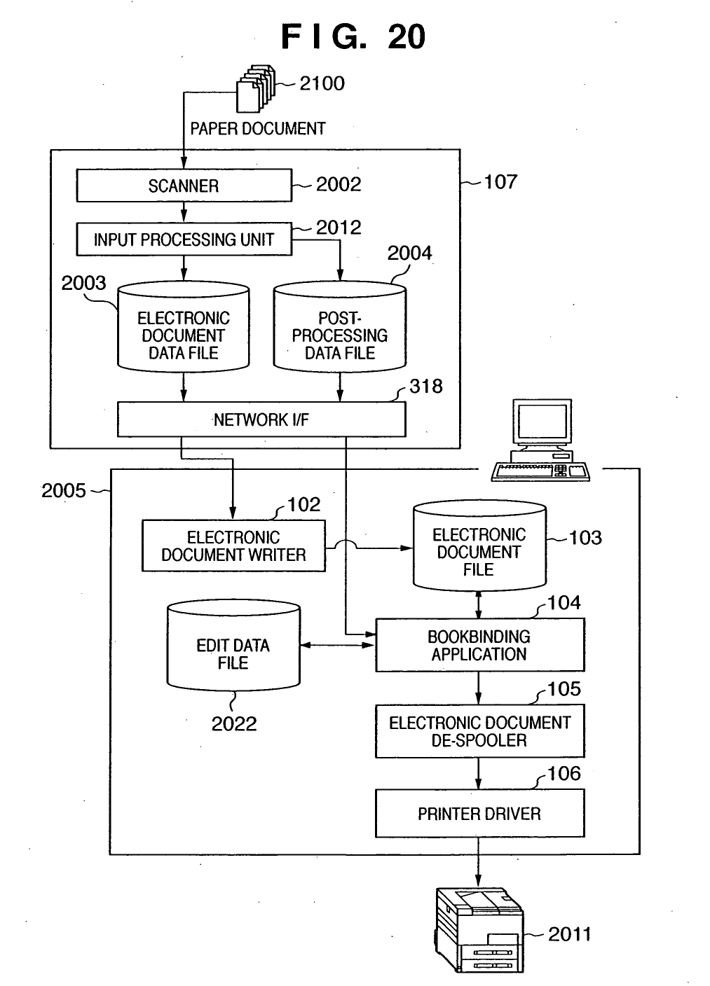

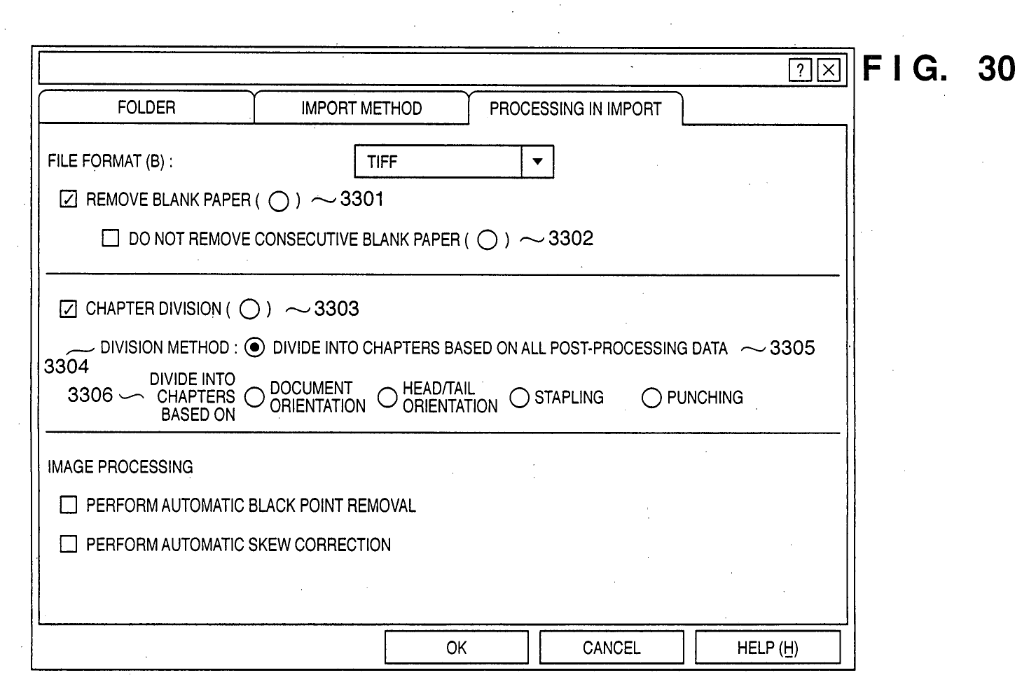

Hereinafter, computerizing a paper document is described with reference to FIG. 20. First, an option that can be set by a user in computerizing a paper document is described. According to this embodiment, a processing condition in importing can be set in the user interface shown in FIG. 30. A value of the designated item is stored according to designation in a predetermined storage area, which is referred to at the time of importing process.

The user interface shown in FIG. 30 is displayed when one of the pull-down menus from, e.g., “Edit” in FIG. 19, is selected. If the chapter division check box 3303 is ticked in FIG. 30, a chapter division flag is set. In a case where the chapter division flag is not set, chapter division processing is not performed, and the imported document image is inserted in one chapter.

In a case where the chapter division flag is set, the division method button 3304 is made selectable. For a division method, setting 3305 or 3306 can be selected. According to the setting 3305, all the post-processing data such as stapling and punching performed on the paper document is utilized to divide the document into chapters. According to the setting 3306, part of the post-processing data is selectively utilized to divide the document into chapters. A value indicative of this setting is stored in the area of the RAM provided for each setting. This setting may be stored as a setting file in a hard disk. The setting is referred to when processing shown in FIGS. 20 to 24 is performed.

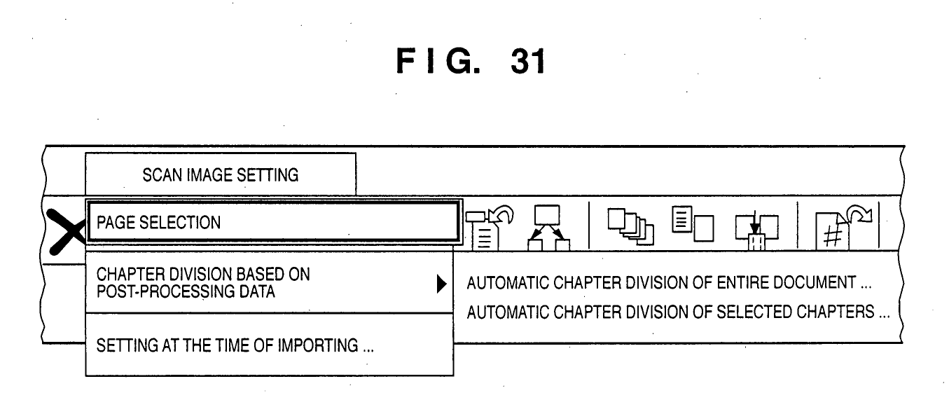

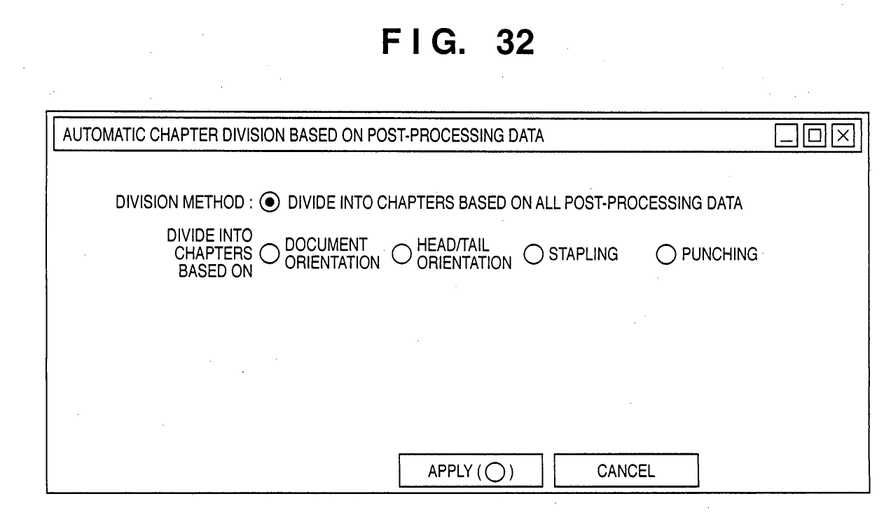

FIG. 32 is a user interface showing an example of a dialogue box for setting details of automatic chapter division. Automatic chapter division is performed on a book file when a user selects an existing book file and designates application of automatic chapter division. The setting in FIG. 30 differs from the setting in FIG. 32 in that it is referred to at the time of document importing. However, the meaning of each check box is the same in FIGS. 30 and 32. FIG. 31 shows a menu screen for displaying the user interface screen shown in FIG. 32. In the menu, a user can designate either the entire document or selected chapters for performing chapter division. Even if the chapter division box 3303 in FIG. 30 is not ticked at the time of document importing, as long as chapter division is performed after the importing is completed, the post-processing data is referred after the importing process and chapter division can be performed based on the post-processing data. As described above, the printing control system according to the present invention comprises two chapter division modes. According to one mode, chapter division is automatically performed, based on determination of whether or not post-printing processing has been performed, at the timing the document data read by a scanner is imported to the bookbinding application program 104 (also called printing application program) of the document processing apparatus. According to the other mode, even after document data is imported to the bookbinding application program 104, chapter division is automatically performed, based on determination of whether or not post-printing processing has been performed, at the timing the chapter division is designated by the user on the bookbinding application program 104.

Import Processing

FIG. 20 is a block diagram showing a schematic construction of a document processing apparatus and so on, provided to show the document processing flow according to the embodiment of the present invention. Referring to FIG. 20, the multi-function printer 107 comprises a scanner 2002 which reads a paper document 2100, and an input processing unit 2012 which converts the paper document into electronic document data and post-processing data (which will be described later in detail) and stores these data in an electronic document data file 2003 and a post-processing data file 2004. Furthermore, the multi-function printer 107 comprises a network I/F 318 which transmits/receives data between the printer and a document processing apparatus 2005. The network I/F 318 transmits data in the electronic document data file 2003 to the electronic document writer 102 through the network I/F 208 (FIG. 2) of the document processing apparatus 2005.

Based on the received electronic document data, the electronic document writer 102 generates data expressible with a detailed format as a document in page unit having a format that can be processable by the bookbinding application program 104 and the printer driver 106, and stores the generated data in the electronic document file 103. The network I/F 318 transmits the data stored in the post-processing data file 2004 to the bookbinding application program 104 of the document processing apparatus 2005. Based on the received post-processing data, the bookbinding application program 104 can edit the electronic document file.

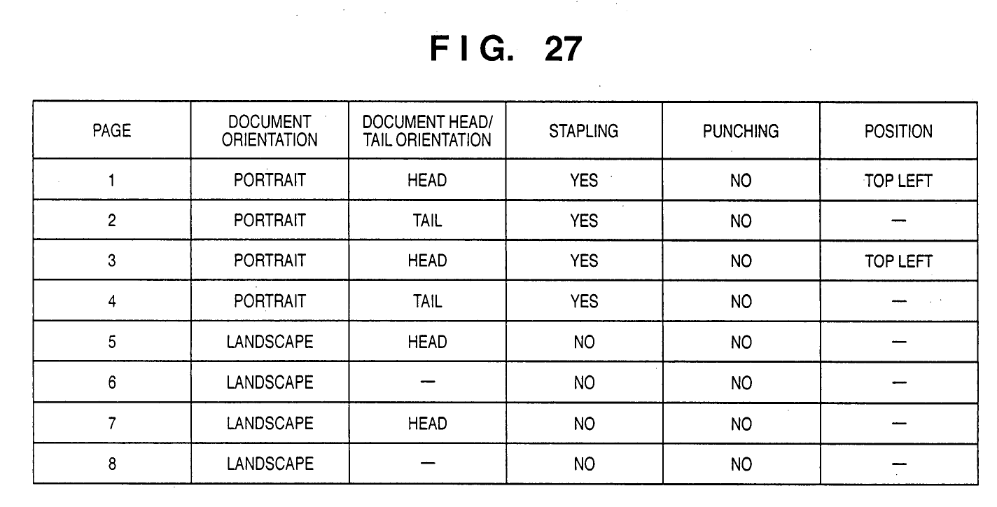

Herein, the post-processing data means data regarding whether or not the setting such as stapling and punching has been performed on the paper document 2100 read by the scanner 2002. FIG. 27 shows post-processing data set in page unit of the inputted document. In FIG. 27, the “page” column indicates the page number scanned and inputted with one surface of the paper document as one page. In a case where the document is double-side printed, the front surface of one paper document is inputted as the first-page data, and the back surface of the document is inputted as the second-page data. The orientation of document” column is determined based on the orientation of the document and printing direction at the time of scanning. It is determined whether or not the document has a portrait orientation or a landscape orientation, and the actual orientation of the document (portrait or landscape) is set. In the “document head/tail orientation” column, “head” is set for a document whose orientation matches with the printing direction (top-and-bottom relation of the document), and “tail” is set for a document whose orientation is opposite to the printing direction.

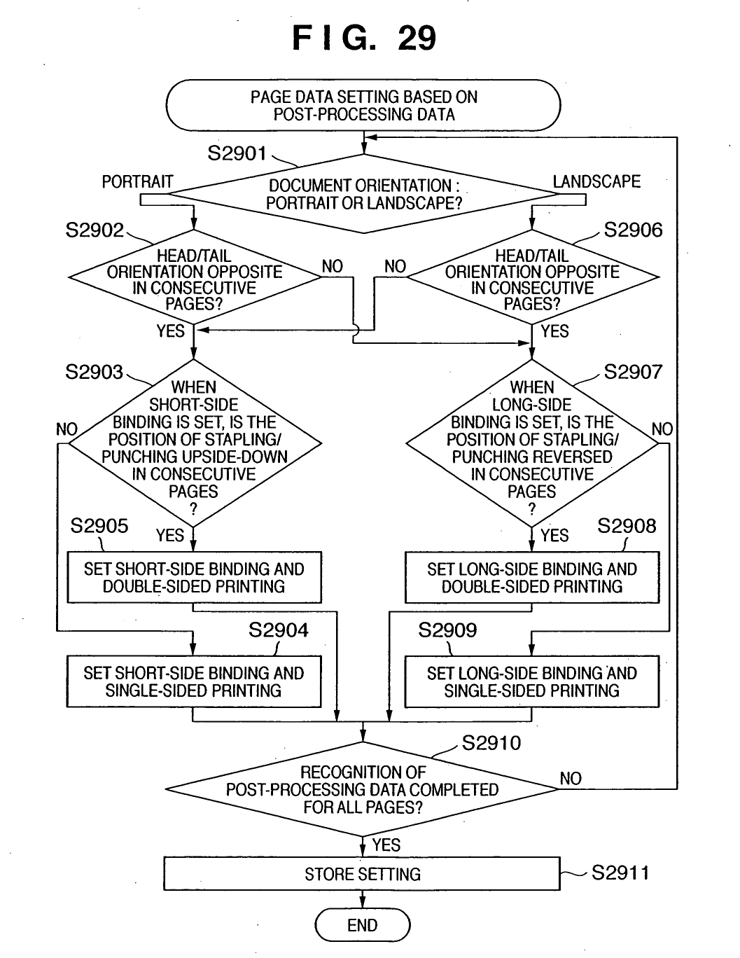

The “stapling” column and the “punching” column are set based on a determination result of whether or not there is a pinhole (stapled pinhole) resulted from stapling, or whether or not there is a hole (punch hole) punched for filing (e.g., 2 punch holes, 26 punch holes for B5 standard, 34 punch holes for A4 standard and so on), which has been performed on the document as post-processing. When this post-processing is detected, “YES” is set, and when the post-processing is not detected, “NO” is set. In the “position” column, data indicative of the stapling or punching position is set. The data indicates the logical position with respect to the document. The “position” data where a stapling or punching hole is detected is used for determining single-sided printing or double-sided printing in subsequent pages in the flowchart shown in FIG. 29 which will be described later. In a case where it is not necessary to distinguish the relation in subsequent pages, at the timing one surface of the document is scanned the stapling or punching position data may be set based on the page where stapling or punching is performed, and the stapling or punching position data does not have to be set for the back surface of the document.

Referring back to FIG. 20, the electronic document de-spooler 105 is a module for outputting data to a printer driver when an electronic document file using the bookbinding application program 104 is to be printed. The electronic document de-spooler 105 reads the electronic document file subjected to document processing out of the hard disk, and generates an output command compatible with the output module of the OS in order to print each page in the format described in the electronic document file. In this stage, the printer driver 106 of the printer 2011, which is used as an output device, is designated as a device driver.

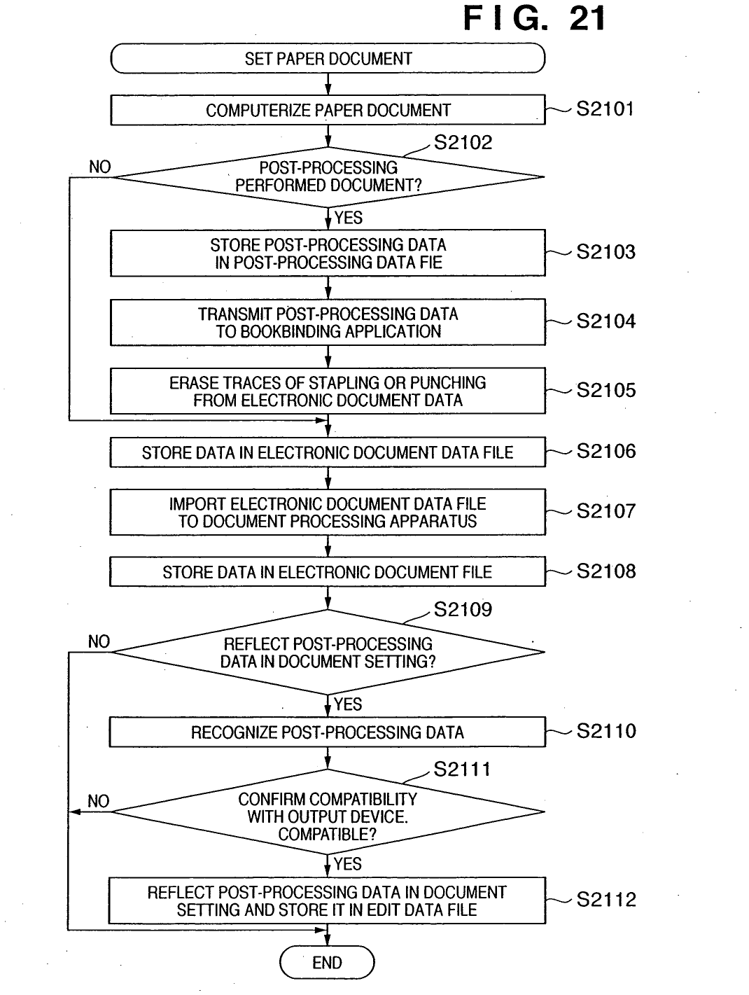

FIG. 21 is a flowchart describing an overall procedure for reflecting the content of post-processing data as document setting on an electronic document file. First, in step S2101, a paper document is set in the scanning plate of the scanner 2002, and inputted in the scanner to computerize the paper document. Considering automation of the process, a scanner having an automatic document feeder is preferable. However, in terms of processing, the type of scanner is not limited to this. For a format of the computerized data, plural formats such as PDF, BMP, JPEG, TIFF and so on may be considered. The present invention is applicable to any format.

Next, in step S2102, the input processing unit 2012 determines at the time of converting the paper document to an electronic document file, whether or not post-processing setting, e.g., setting for binding such as stapling and punching, has been performed on the paper document by analyzing a predetermined area of the read document data. Since stapling or punching is performed in a predetermined area as post-printing processing, it can easily be determined. Since the determination can be realized by a well-known technique, a detailed description is omitted. If it is determined in step S2102 that there is no post-processing setting (No in step S2102), the control proceeds to step S2106, where the input processing unit 2012 stores the scanned electronic document data in the electronic document data file 2003. If it is determined in step S2102 that there is post-processing setting (Yes in step S2102), the control proceeds to step S2103 where the content of the post-processing setting (e.g., FIG. 27) is stored in the post-processing data file 2004.

In step S2104, the network I/F 318 transmits the post-processing data to the bookbinding application program 104 of the document processing apparatus 2005.

In step S2105, the input processing unit 2012 automatically erases the data corresponding to the portion related to post-processing, e.g., stapling holes and punching holes, from the electronic document data read in step S2101, and stores it in the file 2003 as the electronic document data (S2106).

In step S2107, the content of the electronic document data file is imported to the document processing apparatus 2005 and transferred to the electronic document writer 102 of the document processing apparatus 2005.

In step S2108, the electronic document writer 102 generates data expressible with a detailed format as a document in page unit having a format that can be processable by the bookbinding application program 104 and the printer driver 106, and stores the generated data in the electronic document file 103.

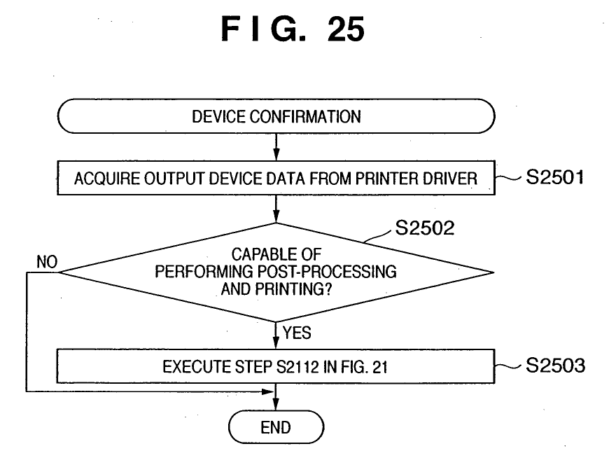

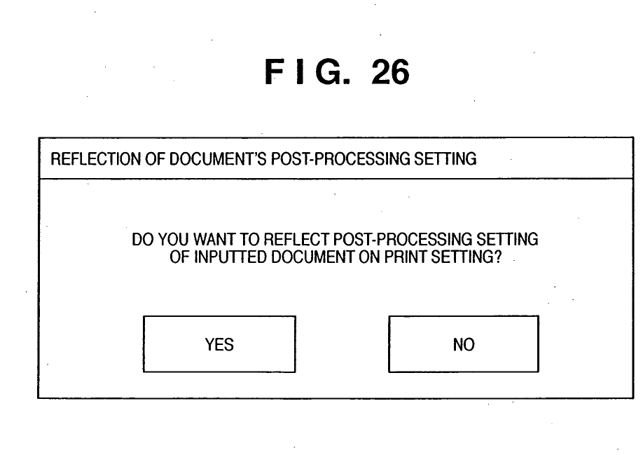

In step S2109, it is determined whether or not the post-processing data performed on the paper document 2100 is to be reflected on the data of the electronic document file as document setting. In this case, an interface screen such as that shown in FIG. 26 is displayed on the display unit of the document processing apparatus, and a user can selectively input desired processing. In a case of not reflecting the post-processing data on the document setting (NO in step S2109), the control ends. In a case of reflecting the post-processing data on the document setting (YES in step S2109), the bookbinding application program 104 recognizes the content of the post-processing data received in step S2104 (S2110), and determines whether or not the document setting based on the post-processing data is compatible with the printer driver 106 of the printer 2011 which is used as an output device (S2111). The determination processing will be described later with reference to FIG. 25. If the post-processing data is not compatible with the printer driver 106 in the determination in step S2111 (NO in step S2111), the control ends. If it is compatible with the printer driver 106 (YES in step S2111), the control proceeds to step S2112 where the post-processing data is reflected on the document setting and stored in the edit data file 2022, then control ends. The interface screen shown in FIG. 26 is not only displayed during the processing to ask for user confirmation in step S2109 in FIG. 21, but may be displayed before starting the processing, e.g., at the time of reading the paper document by the scanner 2002, to determine in advance whether or not to reflect the post-processing data on the document setting.

Determining Device Compatibility

FIG. 25 is a flowchart describing a procedure for determining compatibility with the output device, which is performed in step S2111 in FIG. 21.

In step S2501, data regarding an output function of the output device, which is set by the printer driver 106 as an output device, is acquired. Based on the acquired data, it is determined whether or not the output device is capable of performing printing of the electronic document on which the post-processing data has been reflected. If it is determined that the output device cannot reflect the post-processing data and perform printing (NO in step S2502), the control ends as the output device is not compatible. Meanwhile, if it is determined in step S2502 that the output device is capable of performing printing of the electronic document on which the post-processing data is reflected (YES in step S2502), the control proceeds to step S2503 where the post-processing data is reflected on the document setting and stored in the edit data file, then control ends as described in step S2112 in FIG. 21.

Note although the above description has been provided with reference to FIGS. 20 and 21 on the system having the multi-function printer 107, comprising the input processing unit 2012 which converts the read paper document data to electronic document data and post-processing data and stores these data in the electronic document data file 2003 and post-processing data file 2004, the present invention is not limited to such system. The present invention can be realized in a case where the multi-function printer 107 comprises the scanner unit 2002 and the network I/F 318, and the document data read by the scanner unit 2002 is directly transmitted to the document processing apparatus 2005. In this case, the document data read by the multi-function printer 107 (corresponding to an image reader) is stored in a predetermined folder of the document processing apparatus 2005, which serves as a hot folder, then the set processing, in this case, determination of post-processing, is performed, and the post-processing data and document data are imported to the bookbinding application program 104, which then performs automatic chapter division. The automatic chapter division performed based on the post-processing determination according to the present embodiment is preferably realized by a system structure that is concluded within the document processing apparatus.

Detailed Procedure for Reflecting Post-Processing Data on Document Setting

In this embodiment, the document data read by the scanner 2002 is inputted in a predetermined hot folder of the document processing apparatus 2005. In the hot folder, data that is a base of the electronic document is inputted to the electronic document writer 102, and a command to perform determination of post-processing, e.g., orientation of document, stapling and the like, is inputted to the bookbinding application program 104 directly or through the electronic document writer 102. In the electronic document writer 102, the inputted document data is converted in page unit into an electronic document having an above-described book file format, and stored respectively in the electronic document file 103 and the edit data file 2022. In the electronic document file 103, the data is stored in a standard format called a job ticket according to this embodiment. In the edit data file 2022, document data (see FIG. 3) describing the hierarchical structure of the “book (document)”, “chapter”, and “page” which are unique to the document processing apparatus is stored. In order to reflect the post-processing data as document setting, the recognized post-processing data is reflected on the document setting data 403 having a book file format shown in FIG. 3.

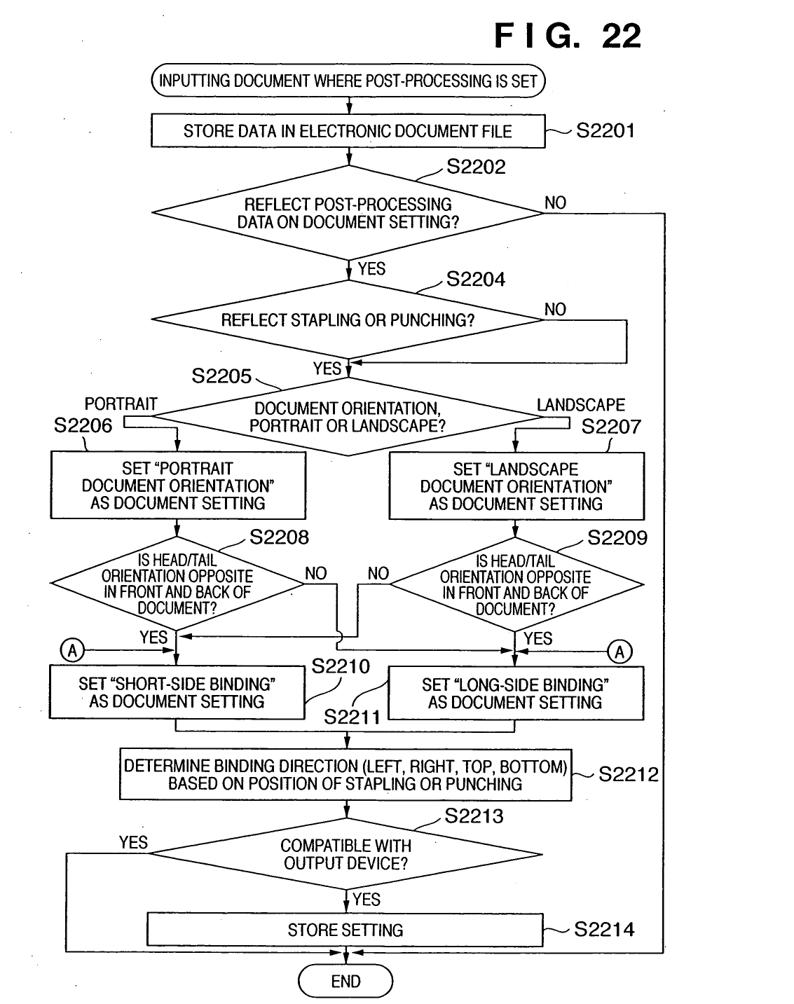

A detailed procedure for reflecting the post-processing data on the document setting is described. FIG. 22 is a flowchart describing a detailed procedure for importing document data read from a paper document, where stapling or punching is set, to the bookbinding application program 104. For importing, there are two methods: one is to drag and drop the document data from a predetermined folder of the document processing apparatus 2005 to a user interface (FIG. 8) of the bookbinding application program 104 using a mouse; and the other is to output the document data to the electronic document writer 102 by the aforementioned hot folder when the document data is stored in the hot folder. Herein, since the processing in steps S2201 to S2202 performed by the document processing apparatus 2005 is the same as steps S2108 to S2109 in the flowchart in FIG. 21 performed by the multi-function printer 107, a description thereof is omitted.

In a case where the bookbinding application program 104 determines that there is setting for stapling or punching in step S2202, the bookbinding application program 104 confirms whether or not to reflect the setting on the document setting in step S2204. The confirmation is made by displaying a dialogue shown in FIG. 26 on the display unit and having a user make selection. Alternatively, a check box may be provided for having a user select the option, “reflect the document's post-processing setting on print setting” in the user interface screen shown in FIG. 30 or FIG. 32. Next, in step S2205, the bookbinding application program 104 determines the document orientation in accordance with the setting “document orientation” in the post-processing data. In a case where the document orientation is portrait in step S2205, the control proceeds to step S2206. In a case where the document orientation is landscape, the control proceeds to step S2207.

In step S2206 where the document orientation is portrait, the bookbinding application program 104 sets “portrait document orientation” in the document setting data 403 shown in FIGS. 4A and 4B. In step S2208, the bookbinding application program 104 compares the “document's head/tail orientation” in the post-processing data with respect to the front surface and back surface of the document. If the head/tail orientation data is opposite in the front and back of the document (Yes in step S2208), “short-side binding” is set as a binding direction in the document setting data 403 (S2210).

Meanwhile, in step S2207 where the document orientation is landscape, the bookbinding application program 104 sets “landscape document orientation” in the document setting data 403 shown in FIGS. 4A and 4B.

In step S2209, the bookbinding application program 104 compares the “document's head/tail orientation” in the post-processing data with respect to the front surface and back surface of the document. If the head/tail orientation data is opposite in the front and back of the document (Yes in step S2209), the bookbinding application program 104 sets “long-side binding” as a binding direction in the document setting data 403 (S2211).

In the determination of head/tail orientation in step S2208, if the head/tail orientation data is not opposite in the front and back of the document (No in step S2208), the control proceeds to step S2211 where the bookbinding application program 104 sets “long-side binding” as a binding direction in the document setting data 403 (S2211).

Meanwhile, in the determination of head/tail orientation in step S2209, if the head/tail orientation data is not opposite in the front and back of the document (No in step S2209), the control proceeds to step S2210 where the bookbinding application program 104 sets “short-side bindings as a binding direction in the document setting data 403 (S2210).

Next, in step S2212, if setting for stapling or punching is performed, the bookbinding application program 104 recognizes the binding position in the position” column of the post-processing data, decides the position (left, right, top, bottom) of the page based on the binding direction determined in the foregoing step, and sets the binding position along with the binding form that has been set in step S2210 or S2211 (S2212).

In step S2213, the bookbinding application program 104 confirms whether or not the post-processing setting is compatible with the printer driver 106 of the printer 2011, which is set as an output device by the bookbinding application program 104. Since the determination of compatibility of the device performed in step S2204 is similar to the processing in step S2111 in FIG. 21, a description thereof is omitted. Based on the determination in step S2213, if the post-processing data is compatible with the device, the post-processing data is decided as the document setting data 403 and stored in the edit data file 2022.

By virtue of the above-described processing, when a document processing apparatus generates an electronic document based on a printed document, it is possible to reflect the post-processing data performed in the printed document on the document setting of the electronic document. Therefore, it eliminates the user's burdensome operation of manually performing each setting after the paper document is inputted.

Correcting Post-Processing Data

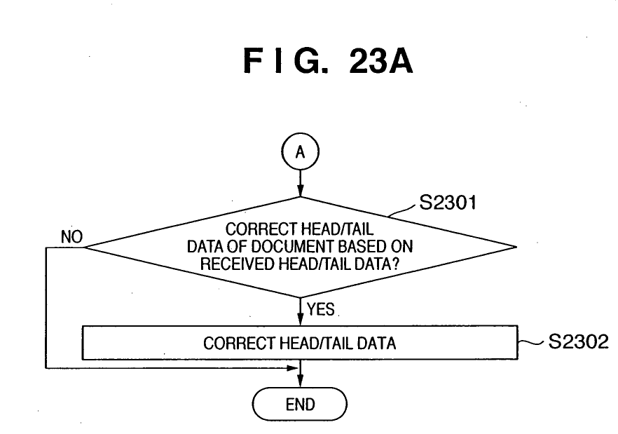

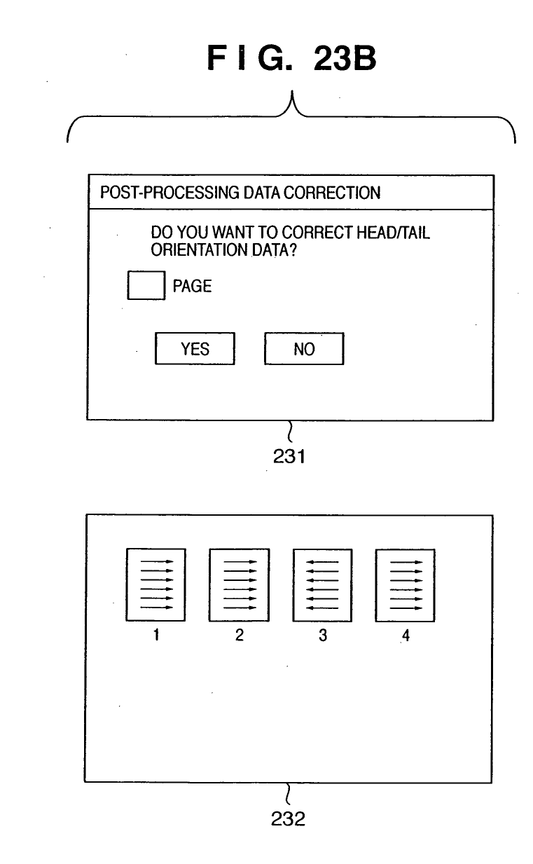

It is also possible to perform correction on post-processing data by the document processing apparatus 2005. For instance, assume that a paper document is erroneously set in the scanner 2002 and documents having different head/tail orientations are imported. In this case, as shown in the flowchart in FIG. 23A, an interface screen such as that shown in FIG. 23B (231 in FIG. 23B) is displayed on the CRT 210 after the post-processing data recognition process is performed in FIG. 22 (e.g., (A) subsequent to step S2208 or S2209) to confirm that whether or not it is necessary to correct the detected setting of the head/tail orientation (S2301). Then, the head/tail orientation data may be corrected with respect to the page designated on the interface screen (S2302). At the time of confirmation in step S2301, the CRT controller (CRTC) 206 may control the CRT 210 to display briefly the layout of the post-processing data setting of the imported document as indicated by reference numeral 232 in FIG. 23B. Referring to reference numeral 232 in FIG. 23B, the pages 1, 2 and 4 have a “head” orientation, where the document orientation matches the printing direction (the direction of left to right indicated by the arrow), and the page 3 has a “tail” orientation, where the document orientation is opposite to the printing direction.

The correction of post-processing data is not limited to head/tail orientation data, but may be realized with respect to the document orientation and the setting for binding. With respect to the recognition result of each data, user confirmation may be performed, and in accordance with the confirmation, correction of each data may be performed.

Chapter Division Based on Post-Processing Data

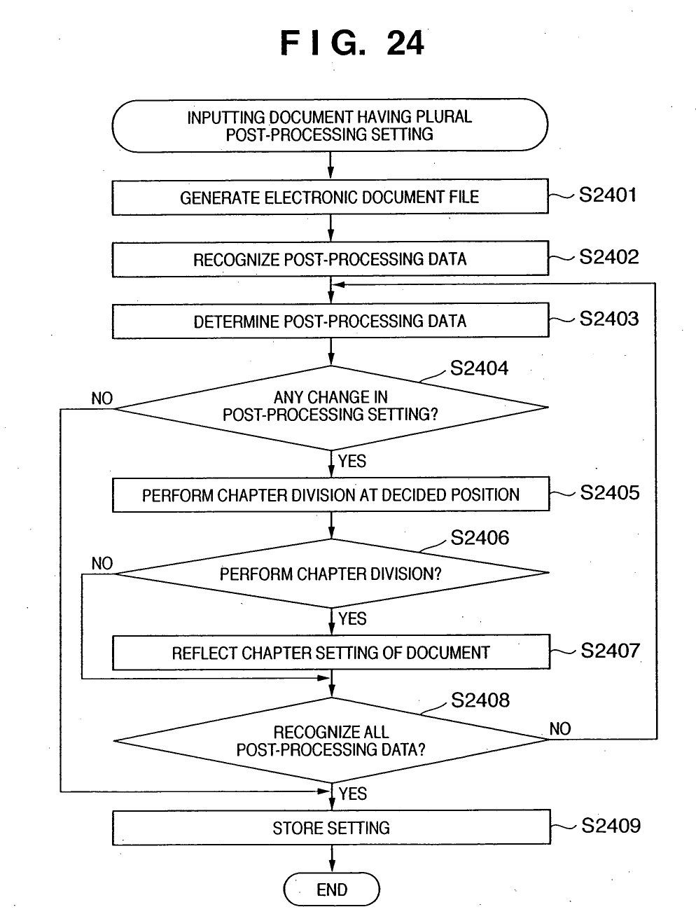

When plural types of paper documents are inputted by scanning and imported to the document processing apparatus 2005, there are cases that different post processing is performed on each type of document. The bookbinding application program 104 uses the difference as determination data for specifying a position of chapter division which divides the document into chapters constituting a “book” (document). FIG. 24 is a flowchart describing a procedure for performing chapter division utilizing the post-processing data. First, the electronic document writer 102 shown in FIG. 20 is employed to generate the electronic document file 103 based on the data imported to the document processing apparatus 2005 (S2401). Then, post-processing data transmitted from the multi-function printer 107, which has scanned and inputted the paper document 2100, is recognized (S2402). Herein, recognition of post-processing data is performed sequentially from page 1 with respect to “document orientation”, “stapling”, and “punching” among the items of post-processing data shown in FIG. 27. To the effect of the present invention, the post-processing data employed in chapter division is not necessarily limited to “document orientation”, “stapling” and “punching”, but it may be arbitrarily selected by a user from, e.g., the interface screen shown in FIG. 30 (see 3305 and 3306 in FIG. 30).

In step S2403, it is determined whether or not there is a difference in the content of the post-processing data between the previous page and the following page. Since data in the fist page cannot be compared with the previous page, it is utilized as a reference for comparison with the next page. In step S2404, it is determined whether or not any setting is different from the setting of previous page with respect to one of the items of post-processing data. If there is no change in post-processing data in the determination in step S2404 (No in step S2404), data indicative of not performing chapter division is stored in the chapter data list 404 and stored in the edit data file 2022.

In the determination in step S2404, if there is a change in post-processing data, such as a case where stapling designation is set from page 1 to page N-1 and no-stapling designation is set from page N on, it is determined that different post-processing is performed on the document from page 1 to page N-1 and the document from page N on. Therefore, the Nth page is decided as a position to perform chapter division (S2405).

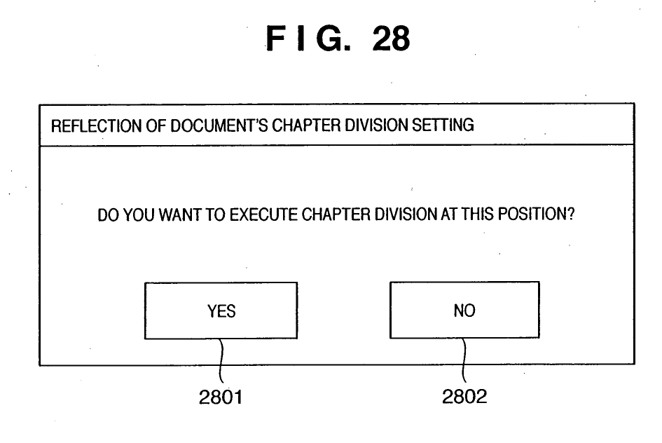

In step S2406, user confirmation is performed as to whether or not to perform chapter division at the position determined in the above step, and the CRT controller (CRTC) 206 controls the CRT 210 to display an interface screen shown in FIG. 28 on the CRT 210. If a user inputs “No” (2802) to the chapter division on the interface screen (FIG. 28), chapter division is not performed at the position determined by the processing of bookbinding application program 104, and the document is processed as consecutive chapters constituting the electronic document file. Then, the control proceeds to step S2408.

Meanwhile, if a user inputs “Yes” (2801) to the chapter division (Yes in step S2406), the electronic document file is chapter-divided at the position determined in step S2405 by the processing of bookbinding application program 104. When execution of chapter division is selected by the user (Yes in step S2406), information designating chapter division at Nth page is set in step S2407 in the chapter data list 404 (see FIG. 3) of the document data stored in the edit data file 2022.

If determination has not been made with respect to post-processing data of all pages (No in step S2408), the control returns to step S2403 to perform determination of post-processing data (S2408). If determination has been made with respect to post-processing data of all pages (Yes in step S2408), the determination results of chapter division set so far in the chapter data list 404 are stored (S2409). Herein, in a case where chapter division is performed once and the chapter division determination result is reflected on the chapter data list 404 in step S2407, the data from the page that has been chapter-divided last (in the above example, N represents the divided page) to the last page is regarded as a new chapter, and the new chapter is set in the chapter data list 404 in FIG. 3.

By the above-described processing, the breakpoint of electronic document can be determined based on a content of post-processing data, and it is possible to reflect the content of chapter division as document setting on the electronic document.

Editing Pages Based on Post-Processing Data

In FIG. 24, the above description has been provided on, in the case of importing plural types of paper documents to the document processing apparatus 2005, determination of a page where post-processing setting changes with respect to the “document orientation, “stapling” and punching” among the items of post-processing data to perform chapter division at the page where there is a change in the setting content. In FIG. 29, a description is provided on a case where the post-processing data is utilized to determine a relation between pages of the electronic document (e.g., long-side binding or short-side binding, single-sided printing or double-sided printing), and the determination is reflected on the document setting of the electronic document. Post-processing data in the previous page is compared with post-processing data of the subsequent page, and each step in the flowchart in FIG. 29 is executed.

In step S2901, the document orientation (portrait or landscape) of both pages is determined. If the document orientation is portrait, the control proceeds to step S2902. If the document orientation is landscape, the control proceeds to step S2906. If the document orientation is different between the previous page and the subsequent page, it is subjected to chapter division in the processing subsequent to step S2404 in FIG. 24. Since the description of chapter division is redundant, the description is not provided herein.

In step S2902, it is determined whether or not the head/tail orientation of the document is opposite between the previous page and the following page. If it is not opposite (No in step S2902), the control proceeds to step S2907. If it is opposite (Yes in step S2902), the control proceeds to step S2903.

In step S2903, it is determined with respect to the page setting “short-side binding” whether or not the position of stapling or punching is upside-down between the previous page and the subsequent page. If it is upside-down (Yes in step S2903), short-side binding and double-sided printing is determined (S2905). If it is not upside-down (No in step S2903), short-side binding and single-sided printing is determined (S2904).

Meanwhile, in a case where the document orientation is landscape, it is determined in step S2906 whether or not the head/tail orientation of the document is opposite between the previous page and the subsequent page. If it is not opposite (No in step S2906), the control proceeds to step S2903. If it is opposite (Yes in step S2906), the control proceeds to step S2907.

In step S2907, it is determined with respect to the page setting “long-side binding” whether or not the position of stapling or punching is reversed between the previous page and the subsequent page. If it is reversed (Yes in step S2907), long-side binding and double-sided printing is determined (S2908). If it is not reversed (No in step S2907), long-side binding and single-sided printing is determined (S2909).

In step S2910, it is determined whether or not recognition of post-processing data of previous page has been completed. If it is not completed, the control returns to step S2901. If it is completed, the control proceeds to step S2911 where the determination results of binding orientation and single-sided printing or double-sided printing (S2904, S2905, S2908, S2909) are stored in the document setting data 403 (FIG. 3) as a book attribute, and the control ends.

By the above-described processing, post-processing data is utilized to determine the relation between pages of an electronic document (e.g., long-side binding or short-side binding, single-sided printing or double-sided printing), and the relation can be reflected on document setting of the electronic document.

Note that the sequence of the processing in each of the flowcharts described in the above embodiments can be changed as long as the processing does not become incomplete. Note that the present invention can be applied to a system constituted by a plurality of devices (e.g., host computer, interface, reader, printer) or to an apparatus comprising a single device (e.g., copying machine, printer, facsimile machine).

Further, the object of the present invention can also be achieved by providing a storage medium, storing program codes of software realizing the above-described functions of the embodiments, to a computer (CPU or MPU) of the system or apparatus, reading the program codes, by the computer of the system or apparatus, from the storage medium, then executing the program. In this case, the program codes read from the storage medium realize the functions according to the embodiments, and the storage medium storing the program codes constitutes the invention.

Further, the storage medium, such as a floppy (registered trademark) disk, hard disk, an optical disk, a magneto-optical disk, CD-ROM, CD-R, a magnetic tape, a non-volatile type memory card, and ROM can be used for providing the program codes.

Furthermore, besides aforesaid functions according to the above embodiments are realized by executing the program codes which are read by a computer, the present invention includes a case where an OS (operating system) or the like working on the computer performs part or the entire processes in accordance with designations of the program codes and realizes functions according to the above embodiments.

Furthermore, the present invention also includes a case where, after the program codes read from the storage medium are written in a function expansion card which is inserted into the computer or in a memory provided in a function expansion unit which is connected to the computer, a CPU or the like contained in the function expansion card or unit performs part or the entire processes in accordance with designations of the program codes and realizes functions of the above embodiments.

According to the present invention, in a case where an electronic document is generated based on a printed document by a document processing apparatus, it is possible to determine breakpoints in the electronic document in accordance with the content of post-processing setting (also referred to as post-processing data) performed on the printed document. Therefore, the content of chapter division can be reflected on the electronic document as document setting.

Furthermore, according to the present invention, it is possible to reflect the setting of post-processing performed on the printed document on the document setting of the electronic document. Accordingly, it is possible to eliminate the user's burdensome operation of manually performing each setting after the paper document is inputted.

Still further, it is possible to determine the relation between pages of the electronic document based on the content of post-processing data, and reflect the determination on the electronic document as document setting.

As many apparently widely different embodiments of the present invention can be made without departing from the spirit and scope thereof, it is to be understood that the invention is not limited to the specific embodiments thereof except as defined in the claims.

### Claim of Priority

This application claims priority from Japanese Patent Application No. 2003-383903 filed on Nov. 13, 2003, which is hereby incorporated by reference herein.

1. A document processing apparatus comprising:
registration means for registering data indicative of post-processing setting, which has been performed on a sheet document in page unit, as document setting of a generated electronic document; and
generation means for generating printing data by reflecting the registered document setting on the generated electronic document.

2. A document processing apparatus comprising:
electronic document generation means for generating an electronic document based on image data of a sheet document, which is inputted by image input means in page unit;
determination means for recognizing, in units of consecutive pages, data indicative of post-processing setting which is performed on each page of the sheet document and determining whether or not the data indicative of post-processing setting has changed; and
chapter division means for recognizing a page, which is determined by said determination means that the data indicative of post-processing setting has changed, as a breakpoint of the inputted sheet document, and registering document setting of the electronic document to perform chapter division at said page.

3. The document processing apparatus according to claim 1, wherein the data indicative of post-processing setting includes at least one of information including: a portrait or landscape orientation of the inputted sheet document, a head or tail orientation of the document, stapling on the document, and punching on the document.

4. The document processing apparatus according to claim 2, wherein said determination means determines based on the data indicative of post-processing setting whether or not a relation of a consecutive page unit is double-sided printing or single-sided printing, and
said chapter division means registers a result of determination as document setting of the electronic document.

5. A document processing method comprising:
a registration step of registering data indicative of post-processing setting, which has been performed on a sheet document in page unit, as document setting of a generated electronic document; and
a generation step of generating printing data by reflecting the registered document setting on the generated electronic document.

6. A document processing method comprising:
an electronic document generation step of generating an electronic document based on image data of a sheet document, which is inputted by image input means in page unit;
a determination step of recognizing, in units of consecutive pages, data indicative of post-processing setting which is performed on each page of the sheet document and determining whether or not the data indicative of post-processing setting has changed; and
a chapter division step of recognizing a page, which is determined in said determination step that the data indicative of post-processing setting has changed, as a breakpoint of the inputted sheet document, and registering document setting of the electronic document to perform chapter division at said page.

7. The document processing method according to claim 5, wherein the data indicative of post-processing setting includes at least one of information including: a portrait or landscape orientation of the inputted sheet document, a head or tail orientation of the document, stapling on the document, and punching on the document.

8. The document processing method according to claim 6, wherein in said determination step, it is determined based on the data indicative of post-processing setting whether or not a relation of a consecutive page unit is double-sided printing or single-sided printing, and
in said chapter division step, a result of determination is registered as document setting of the electronic document.

9. A document processing program executed by a computer, comprising:
a registration module for registering data indicative of post-processing setting, which has been performed on a sheet document in page unit, as document setting of a generated electronic document; and
a generation module for generating printing data by reflecting the registered document setting on the generated electronic document.

10. A document processing program executed by a computer, comprising:
an electronic document generation module for generating an electronic document based on image data of a sheet document, which is inputted by image input means in page unit;
a determination module for recognizing, in units of consecutive pages, data indicative of post-processing setting which is performed on each page of the sheet document and determining whether or not the data indicative of post-processing setting has changed; and
a chapter division module for recognizing a page, which is determined by said determination module that the data indicative of post-processing setting has changed, as a breakpoint of the inputted sheet document, and registering document setting of the electronic document to perform chapter division at said page.
